(19) United States
(12) Patent Application Publication
(10) Pub. No.: US 2018/0081691 A1
(43) Pub. Date: Mar. 22, 2018

(54) REPLAYING SPECULATIVELY DISPATCHED LOAD-DEPENDENT INSTRUCTIONS IN RESPONSE TO A CACHE MISS FOR A PRODUCING LOAD INSTRUCTION IN AN OUT-OF-ORDER PROCESSOR (OoP)

(71) Applicant: QUALCOMM Incorporated, San Diego, CA (US)

(72) Inventors: Milind Ram Kulkarni, Raleigh, NC (US); Rami Mohammad Al Sheikh, Morrisville, NC (US); Raguram Damodaran, San Diego, CA (US)

(21) Appl. No.: 15/271,366

(22) Filed: Sep. 21, 2016

(51) Int. Cl. G06F 9/38; G06F 9/30; G06F 12/0875

(52) U.S. Cl. CPC G06F 9/3838; G06F 9/30043; G06F 9/3855; G06F 2212/452; G06F 9/30101; G06F 12/0875; G06F 9/3867

(57) ABSTRACT

Replaying speculatively dispatched load-dependent instructions in response to a cache miss for a producing load instruction in an out-of-order processor (OoP) is disclosed. To allow for a scheduler circuit to restore register dependencies in a register dependency tracking circuit for a replay operation in response to a cache miss for execution of a load instruction, the scheduler circuit includes a replay circuit. The replay circuit includes a load dependency tracking circuit. The replay circuit is configured to track dependencies of dispatched load instructions in the load dependency tracking circuit. The replay circuit uses these tracked dependencies to restore register dependencies for the dispatched load instructions in the register dependency tracking circuit in response to a replay operation. Thus, the load instruction does not have to be re-allocated to restore register dependencies in the register dependency tracking circuit used for re-dispatching load-dependent instructions.

### BACKGROUND

### I. Field of the Disclosure

The technology of the disclosure relates generally to instruction pipelining in out-of-order processors (OoPs), and more particularly to scheduling dispatch of load-dependent instructions to execution units for execution in an OoP.

### II. Background

Instruction pipelining is a processing technique whereby the throughput of computer instructions being executed by a processor may be increased. In this regard, handling of each instruction is split into a series of steps as opposed to each instruction being processed sequentially and executed fully before processing a next instruction. These steps are executed in an instruction pipeline composed of multiple stages. There are several cycles between the time an instruction is fetched from memory and the time the instruction is actually executed as the instruction flows through various pipeline stages of an instruction pipeline.

In this regard, FIG. 1 is a block diagram of an exemplary processor-based system 100 that includes an out-of-order processor (OoP) 102. The OoP 102 includes an instruction processing system 104 configured to process instructions 106 to be executed. In this regard, the instructions 106 are fetched by an instruction fetch circuit 108 from an instruction memory 110. An instruction cache 112 may also be provided in the processor-based system 100, as shown in FIG. 1, to cache the instructions 106 from the instruction memory 110 to reduce latency in the instruction fetch circuit 108 fetching the instructions 106. The instruction fetch circuit 108 is configured to provide the fetched instructions 106 into one or more instruction pipelines I₀-I_{N} in the instruction processing system 104 to be pre-processed before the fetched instructions 106 reach an execution circuit 114 to be executed. An instruction decode circuit 116 is configured to decode the fetched instructions 106 fetched by the instruction fetch circuit 108 to determine the type of instruction and actions required, which in turn is used to determine in which instruction pipeline I₀-I_{N} the instructions 106 should be placed.

With continuing reference to FIG. 1, a dispatch circuit 118 (also known as an “issue circuit”) can dispatch the instructions 106 out-of-order to execution units Ex₀-Ex_{N} in the execution circuit 114 after identifying and arbitrating among instructions 106 that have all their source registers ready. The dispatch circuit 118 can be configured to speculatively dispatch dependent instructions 106 on the assumption that a producing load instruction 106 will execute before the dependent instructions 106 execute in an execution unit Ex₀-Ex_{N}. In this regard, FIG. 2 illustrates a dispatch circuit 200 that can be provided in the OoP 102 in FIG. 1 to dispatch instructions 106 once their source registers are available. The dispatch circuit 200 includes an instruction silo 202 that stores received instructions 106. Some instructions 106 in the instruction silo 202 may have source registers that are dependent on the production of other instructions 106 to be executed. An instruction wake-up circuit 204 is provided that is configured to “wake up” instructions 106 that have register dependencies for dispatch once the instructions 106 from which they depend are dispatched. A picker circuit 206 is provided that is configured pick instructions 106 that are ready to be dispatched based on whether register dependencies exist for such instructions 106. In this regard, the instruction wake-up circuit 204 includes a register dependency tracking circuit 208 that includes rows for each instruction 106 to be dispatched. The number of rows in the register dependency tracking circuit 208 provides a window size of the dispatch circuit 200. Columns in the register dependency tracking circuit 208 are provided for each register R0-RP. Dependency bits 210 are set (‘1’ in this example) in a corresponding row and column to note a register dependency for each instruction 106 if a register dependency exists. The picker circuit 206 uses the state of these dependency bits 210 to determine if an instruction 106 is ready to be picked and dispatched. The instruction wake-up circuit 204 sets dependency bits 210 of an instruction 106 to ‘0’ in this example to “wake up” the instruction 106 indicating that such instruction 106 is ready to be picked and dispatched since the instruction 106 that created the register dependency has been dispatched.

With reference back to FIG. 1, if an instruction 106 dispatched by the dispatch circuit 118 to an execution unit Ex₀-Ex_{N} to be executed is a load instruction 106, the execution unit Ex₀-Ex_{N} will access a cache memory 120 at an address of the source register of the load instruction 106 to obtain the load data for executing the load instruction 106. If the data at the address of the source register of the load instruction 106 is not contained in the cache memory 118, a cache miss occurs. A higher level cache memory(ies) 122 or a system memory 124 may subsequently be accessed to obtain the load data at the address of the source register of the load instruction 106. However, in each of these cache miss scenarios, the dispatch circuit 118 may have already speculatively dispatched load-dependent instructions 106 that are dependent on the produced results of a previously dispatched load instruction 106. However, if the load data for the dispatched load instruction 106 is not available, the dispatched load instruction 106 may not be able to be executed to resolve the register dependency of the dispatched load-dependent instructions 106 by the time the dispatched load-dependent instructions 106 are ready to be executed.

### SUMMARY OF THE DISCLOSURE

Aspects of the present disclosure involve replaying speculatively dispatched load-dependent instructions in response to a cache miss for a producing load instruction in an out-of-order processor (OoP). In exemplary aspects disclosed herein, a scheduler circuit is provided in an instruction pipeline in an OoP. The scheduler circuit is configured to dispatch instructions into instruction pipelines to be executed by execution units once their source registers are ready. The scheduler circuit includes a register dependency tracking circuit. The scheduler circuit is configured to track direct and indirect source register dependencies in the register dependency tracking circuit for controlling dispatch of load-dependent instructions after their producing instructions are dispatched so that the source registers of the load-dependent instructions are ready before execution. To increase throughput efficiency, the scheduler circuit is configured to speculatively dispatch load-dependent instructions after dispatching of their producing load instruction on the assumption that the load data for executing the producing load instruction will be available from a next level cache memory (i.e., a cache hit). The register dependencies for the speculatively dispatched load-dependent instructions are cleared from the register dependency tracking circuit. However, if the load data is not available (i.e., a cache miss), the scheduler circuit is configured to replay dispatching of direct and indirect load-dependent instructions on the producing load instruction that incurred the cache miss. In this regard, the scheduler circuit is configured to enter a replay operation to replay dispatching of the direct and indirect load-dependent instructions once the load data for the producing load instruction is available. The scheduler circuit restores a stored state of the register dependencies for the load-dependent instructions to be replayed from a shadow register dependency tracking circuit into the register dependency tracking circuit to be used to re-dispatch the load-dependent instructions. In this manner, the load dependencies for the load-dependent instructions that are dependent on the producing load instruction that incurred a cache miss will be resolved before their execution.

In examples disclosed herein, to allow for the scheduler circuit to restore the register dependencies from the shadow register dependency tracking circuit into the register dependency tracking circuit for a replay operation, the scheduler circuit also includes a replay circuit. The replay circuit includes a load dependency tracking circuit. The replay circuit is configured to track dependencies of dispatched load instructions. In this manner, the replay circuit can use the load dependency tracking circuit to determine which register dependencies in the shadow register dependency tracking circuit are to be used to update the register dependencies for the dispatched load instructions in the register dependency tracking circuit in response to a replay operation. Load instructions are not used by the scheduler circuit in this example to restore the load dependencies in the register dependency tracking circuit. Thus, load instructions do not have to be re-allocated in a reservation circuit to restore the register dependencies in the register dependency tracking circuit, which would otherwise consume additional instruction space in the scheduler circuit and require re-dispatching of the load instructions. In other words, a dispatched load instruction can be de-allocated in a reservation circuit on its first dispatch, because the information needed to restore the register dependencies of the load instruction in the register dependency tracking circuit can be obtained from the load dependency tracking circuit. Further, load-dependent instructions can consume the results from producing load instructions without waiting for the load instructions to be re-dispatched and executed. As another example, having the load dependency tracking circuit also allows all direct and indirect register dependencies to be restored in the register dependency tracking circuit in response to the same restore operation without having to use the dispatch of the directly dependent load-dependent instructions to restore the register dependencies of indirectly dependent load-dependent instructions.

In this regard, in one exemplary aspect, a scheduler circuit for dispatching instructions in an instruction pipeline in an OoP is provided. The scheduler circuit is configured to update register dependency information in a plurality of instruction entries in a register dependency tracking circuit, each instruction entry among the plurality of instruction entries corresponding to register dependency information of a dependent instruction to be dispatched. The scheduler circuit is also configured to update shadow register dependency information in a plurality of shadow instruction entries in a shadow register dependency tracking circuit, each shadow instruction entry among the plurality of shadow instruction entries corresponding to the register dependency information in an instruction entry in the register dependency tracking circuit for the dependent instruction to be dispatched. The scheduler circuit also comprises a replay circuit. The replay circuit is configured to issue a replay command for register load dependencies indicated in a plurality of load instruction entries in a load dependency tracking circuit, in response to a received replay request for a register corresponding to a dispatched load instruction. The scheduler circuit is further configured to restore the shadow register dependency information from the plurality of shadow instruction entries in the shadow register dependency tracking circuit in response to the replay command issued by the replay circuit for each register load dependency, into the register dependency information in the plurality of instruction entries in the register dependency tracking circuit corresponding to the shadow register dependency information for each register load dependency from the replay circuit.

In another exemplary aspect, a scheduler circuit for dispatching instructions in an instruction pipeline in an OoP is provided. The scheduler circuit comprises a means for updating register dependency information in a plurality of instruction entries, each instruction entry among the plurality of instruction entries corresponding to register dependency information of a dependent instruction to be dispatched. The scheduler circuit also comprises a means for updating shadow register dependency information in a plurality of shadow instruction entries, each shadow instruction entry among the plurality of shadow instruction entries corresponding to the register dependency information in an instruction entry for the dependent instruction to be dispatched. The scheduler circuit also comprises a means for issuing a replay command for register load dependencies indicated in a plurality of load instruction entries, in response to a received replay request for a register corresponding to a dispatched load instruction. The scheduler circuit also comprises a means for restoring the shadow register dependency information from the plurality of shadow instruction entries in response to the means for issuing the replay command for each register load dependency, into the register dependency information in the plurality of instruction entries corresponding to the means for updating the shadow register dependency information for each register load dependency

In another exemplary aspect, a method of scheduling instructions for dispatch to an execution unit in an instruction pipeline of an OoP is provided. The method comprises updating register dependency information in a plurality of instruction entries in a register dependency tracking circuit, each instruction entry among the plurality of instruction entries corresponding to register dependency information of a dependent instruction to be dispatched. The method also comprises updating shadow register dependency information in a plurality of shadow instruction entries in a shadow register dependency tracking circuit, each shadow instruction entry among the plurality of shadow instruction entries corresponding to the register dependency information in an instruction entry in the register dependency tracking circuit for the dependent instruction to be dispatched. The method also comprises issuing a replay command for register load dependencies indicated in a plurality of load instruction entries in a load dependency tracking circuit, in response to a received replay request for a register corresponding to a dispatched load instruction. The method also comprises restoring the shadow register dependency information from the plurality of shadow instruction entries in the shadow register dependency tracking circuit in response to issuing the replay command for each register load dependency, into the register dependency information in the plurality of instruction entries in the register dependency tracking circuit corresponding to the shadow register dependency information for each register load dependency.

In another exemplary aspect, a processor-based system is provided. The processor-based system comprises a cache memory configured to cache load data from a system memory. The processor-based system also comprises an OoP. The OoP comprises an execution circuit configured to execute dispatched instructions and a dispatch circuit configured to dispatch instructions to the execution circuit. The dispatch circuit is configured to update register dependency information in a plurality of instruction entries in a register dependency tracking circuit, each instruction entry among the plurality of instruction entries corresponding to register dependency information of a dependent instruction to be dispatched. The dispatch circuit is also configured to update shadow register dependency information in a plurality of shadow instruction entries in a shadow register dependency tracking circuit, each shadow instruction entry among the plurality of shadow instruction entries corresponding to the register dependency information in an instruction entry in the register dependency tracking circuit for the dependent instruction to be dispatched. The dispatch circuit is configured to restore the shadow register dependency information from the plurality of shadow instruction entries in the shadow register dependency tracking circuit in response to a replay command issued by a replay circuit for each register load dependency, into the register dependency information in the plurality of instruction entries in the register dependency tracking circuit corresponding to the shadow register dependency information for each register load dependency from the replay circuit. The execution circuit is configured to issue a replay request in response to a cache miss to the cache memory in response to execution of a load instruction dispatched from the dispatch circuit. The dispatch circuit is further configured to issue the replay command for the register load dependencies indicated in a plurality of load instruction entries in a load dependency tracking circuit, in response to the received replay request for a register corresponding to a dispatched load instruction.

### BRIEF DESCRIPTION OF THE FIGURES

FIG. 1 is a schematic diagram of an exemplary processor-based system that includes an exemplary out-of-order processor (OoP) configured to schedule and dispatch instructions out-of-order for execution;

FIG. 2 is a schematic diagram of an exemplary dispatch circuit that can be in the OoP in FIG. 1 for tracking register dependencies of dependent instructions for controlling dispatching of dependent instructions;

FIG. 3 is a schematic diagram of an exemplary processor-based system that includes an exemplary OoP that includes an exemplary scheduler circuit configured to speculatively dispatch for execution, load-dependent instructions dependent on dispatched load instructions, and replay such load-dependent instructions in a replay operation based on restored register dependencies for the load-dependent instructions, in response to a cache miss for a producing load instruction;

FIGS. 4A-4E are logical diagrams illustrating exemplary register dependency tracking states in the scheduler circuit in the OoP in FIG. 3, in response to the scheduler circuit speculatively dispatching load-dependent instructions after dispatching of a load instruction and replaying the load-dependent instructions based on restored register dependencies in the scheduler circuit for a replay operation;

FIG. 5 is a flowchart illustrating an exemplary process of the scheduler circuit in FIG. 3 speculatively dispatching load-dependent instructions after dispatching a load instruction and replaying the load-dependent instructions based on restored register dependencies in the scheduler circuit for a replay operation;

FIG. 6 is a schematic diagram of an exemplary replay circuit that can be provided in the scheduler circuit in FIG. 3 for storing register dependencies from dispatched load instructions and issuing a replay command to initiate a replay operation in response to a cache miss for the dispatched load instructions;

FIG. 7 is a schematic diagram of an exemplary instruction valid circuit that can be provided in the scheduler circuit in FIG. 3 for storing and restoring an instruction valid entry associated with load-dependent instructions to be replayed, in response to the replay circuit in FIG. 6 issuing the replay command for the replay operation;

FIG. 8 is a schematic diagram of an exemplary instruction wake-up circuit that can be provided in the scheduler circuit in FIG. 3 for restoring register dependencies for a dispatched load instruction and issuing a valid restore command, in response to the replay circuit in FIG. 6 issuing the replay command for the replay operation;

FIG. 9 is a timing diagram illustrating an exemplary time sequence of signals generated in the replay circuit, the instruction valid circuit, and the instruction wake-up circuit in FIGS. 6-8 for restoring direct and indirect register dependencies in the scheduler circuit, and replaying the dispatch of load-dependent instructions for a replay operation;

FIGS. 10A-10H are logical diagrams illustrating exemplary register dependency tracking states in the scheduler circuit in the OoP in FIG. 3, in response to the scheduler circuit speculatively dispatching load-dependent instructions after dispatching of a load instruction and replaying of the load-dependent instructions based on sequenced restoring of register dependencies in the scheduler circuit for a replay operation;

FIG. 11 is a schematic diagram of another exemplary instruction valid circuit that can be provided in the scheduler circuit in FIG. 3 for storing and sequenced restoring of a valid indicator associated with load-dependent instructions to be replayed, in response to the replay circuit in FIG. 7 issuing the replay command for the replay operation;

FIG. 12 is a schematic diagram of another exemplary instruction wake-up circuit that can be provided in the scheduler circuit in FIG. 3 for sequenced restoring of register dependencies for a dispatched load instruction, in response to the replay circuit in FIG. 7 issuing the replay command for response to the replay operation;

FIG. 13 is a timing diagram illustrating an alternative exemplary time sequence of signals generated in the scheduler circuit in FIG. 3 for sequenced restoring of indirect register dependencies in the scheduler circuit in response to a replay operation; and

FIG. 14 is a block diagram of an exemplary processor-based system that includes a processor that includes one or more processor cores that each can be an OoP that includes a scheduler circuit configured to speculatively dispatch for execution, load-dependent instructions dependent on dispatched load instructions, and replay such load-dependent instructions in a replay operation based on restored register dependencies for the load-dependent instructions, in response to a cache miss for a producing load instruction, including but not limited to the scheduler circuits in FIGS. 3, 7-9, 11, and 12, as a non-limiting examples.

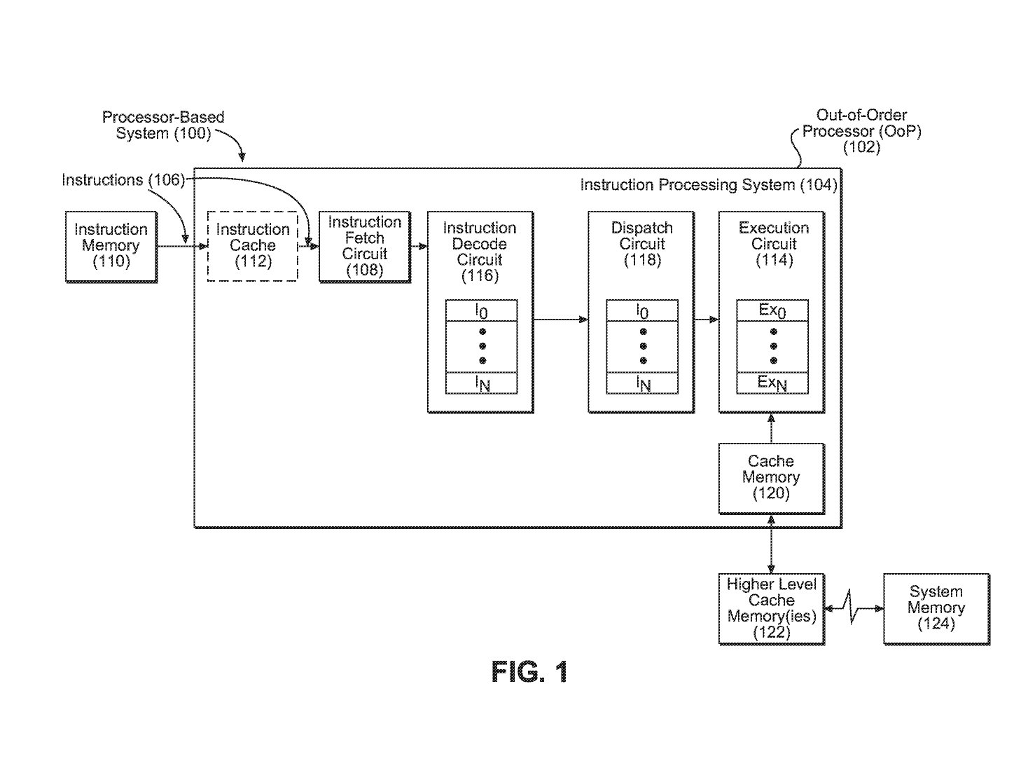

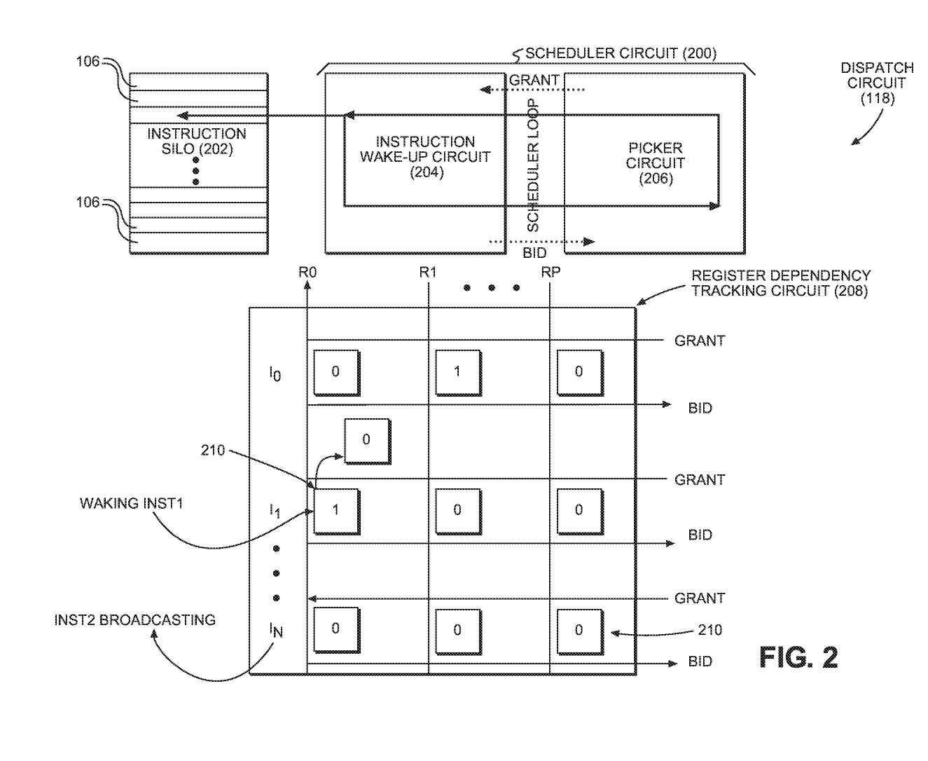

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects of the present disclosure involve replaying speculatively dispatched load-dependent instructions in response to a cache miss for a producing load instruction in an out-of-order processor (OoP). In exemplary aspects disclosed herein, a scheduler circuit is provided in an instruction pipeline in an OoP. The scheduler circuit is configured to dispatch instructions into instruction pipelines to be executed by execution units once their source registers are ready. The scheduler circuit includes a register dependency tracking circuit. The scheduler circuit is configured to track direct and indirect source register dependencies in the register dependency tracking circuit for controlling dispatch of load-dependent instructions after their producing instructions are dispatched so that the source registers of the load-dependent instructions are ready before execution. To increase throughput efficiency, the scheduler circuit is configured to speculatively dispatch load-dependent instructions after dispatching of their producing load instruction on the assumption that the load data for executing the producing load instruction will be available from a next level cache memory (i.e., a cache hit). The register dependencies for the speculatively dispatched load-dependent instructions are cleared from the register dependency tracking circuit. However, if the load data is not available (i.e., a cache miss), the scheduler circuit is configured to replay dispatching of direct and indirect load-dependent instructions on the producing load instruction that incurred the cache miss. In this regard, the scheduler circuit is configured to enter a replay operation to replay dispatching of the direct and indirect load-dependent instructions once the load data for the producing load instruction is available. The scheduler circuit restores a stored state of the register dependencies for the load-dependent instructions to be replayed from a shadow register dependency tracking circuit into the register dependency tracking circuit to be used to re-dispatch the load-dependent instructions. In this manner, the load dependencies for the load-dependent instructions that are dependent on the producing load instruction that incurred a cache miss will be resolved before their execution.

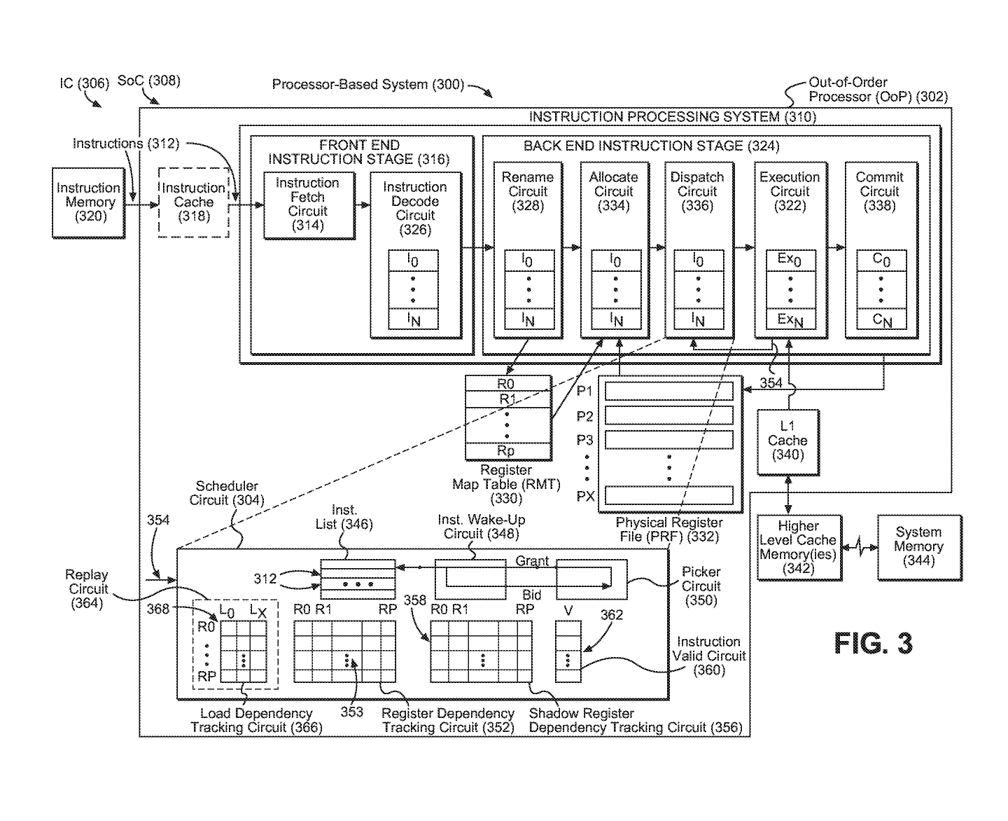

In this regard, FIG. 3 is a schematic diagram of an exemplary processor-based system 300 that includes an exemplary OoP 302 that includes an exemplary scheduler circuit 304 for dispatching instructions to be executed. The OoP 302 can be provide in an integrated circuit (IC) 306, including a system-on-a-chip (SoC) 308, where other supporting components, such as memory, data interfaces, communications interfaces, radio-frequency (RF) circuits, etc., are provided. As will be discussed in more detail below, the scheduler circuit 304 is configured to speculatively dispatch for execution, load-dependent instructions that are dependent on a dispatched load instruction. As will also be discussed in more detail below, the scheduler circuit 304 is also configured to replay such load-dependent instructions in a replay operation based on restored register dependencies for the load-dependent instructions, in response to a cache miss for a producing load instruction. In this manner, the load dependencies for the load-dependent instructions that are dependent on the producing load instruction that incurred a cache miss will be resolved before their execution.

With reference to FIG. 3, the OoP 302 includes an instruction processing system 310 configured to process instructions 312 to be executed. In this regard, the instructions 312 are fetched by an instruction fetch circuit 314 provided in a front end instruction stage 316 of the instruction processing system 310 from an instruction memory 320. An instruction cache 318 may also be provided in the processor-based system 300, as shown in FIG. 3, to cache the instructions 312 from the instruction memory 320 to reduce latency in the instruction fetch circuit 314 fetching the instructions 312. The instruction fetch circuit 314 is configured to provide the fetched instructions 312 into one or more instruction pipelines I₀-I_{N} in the instruction processing system 310 to be pre-processed before the fetched instructions 312 reach an execution circuit 322 in a back end instruction stage 324 to be executed. The front end instruction stage 316 also includes an instruction decode circuit 326 configured to decode the fetched instructions 312 fetched by the instruction fetch circuit 314 to determine the type of instruction and actions required, which in turn is used to determine in which instruction pipeline I₀-I_{N} the instructions 312 should be placed.

With continuing reference to FIG. 3, the fetched instructions 312 placed in one or more of the instruction pipelines I₀-I_{N} are next provided to a rename circuit 328 in the back end instruction stage 324, which is configured to determine if any register names in the decoded instructions 312 need to be renamed to break any register dependencies that would prevent parallel or out-of-order processing. The rename circuit 328 is configured to call upon a register map table (RMT) 330 to rename the logical source and destination register names to available physical register names in a physical register file (PRF) 332 that typically provides more registers than architectural registers available. An allocate circuit 334 in the back end instruction stage 324 reads the physical registers containing source operands from the PRF 332 to determine if the producing instruction 312 responsible for producing the value has been executed.

A dispatch circuit 336 (also known as an “issue circuit”) includes the scheduler circuit 304 that dispatches instructions 312 out-of-order to execution units Ex₀-Ex_{N} in the execution circuit 322 after identifying and arbitrating among instructions 312 that have all their source registers ready. The dispatch circuit 336 can be configured to speculatively dispatch load-dependent instructions 312 on the assumption that the producing load instruction 106 will execute before the load-dependent instruction 312 executes in an execution unit Ex₀-Ex_{N}. A commit circuit 338 provided in the back end instruction stage 324 as a final stage is configured to update the architectural and memory state of the processor-based system 300 for executed instructions 312 and to process exceptions caused by the executed instructions 312.

FIG. 3 illustrates exemplary detail of the scheduler circuit 304 that can be provided in the dispatch circuit 336 in the OoP 302. Because the OoP 302 is configured to execute instructions 312 out-of-order from their listing in the instruction memory 320, the scheduler circuit 304 is configured to schedule the dispatched instructions 312 once their source registers become available. In this regard, the scheduler circuit 304 includes an instruction list 346 that stores instructions 312 received from the allocate circuit 334 to be dispatched and executed in the execution circuit 322. Some instructions 312 in the instruction list 346 may have source registers that are dependent on the production of other instructions 312 yet to be dispatched for execution. In this regard, an instruction wake-up circuit 348 is provided that is configured to “wake up” instructions 312 that no longer have register dependencies to other non-dispatched instructions 312. A picker circuit 350 is provided that is configured to pick instructions 312 from the instruction list 346 that are “woken up,” and thus ready to be dispatched. To track the status of register dependencies of instructions 312 to be dispatched, the scheduler circuit 304 includes a register dependency tracking circuit 352. The register dependency tracking circuit 352 is configured to store register dependency information 353 indicating if instructions 312 in the instruction list 346 are dependent on (i.e., consume) the produced results from designation registers R0-RP of other instructions 312 in the instruction list 346 yet to be dispatched. The instruction wake-up circuit 348 updates the register dependency tracking circuit 352 to remove an indication of register dependencies for the instructions 312 once the producing instructions 312 of such register dependencies are dispatched.

With continuing reference to FIG. 3, if an instruction 312 dispatched by the dispatch circuit 336 to an execution unit Ex₀-Ex_{N} in the execution circuit 322 to be executed is a load instruction 312, data must be loaded from memory to execute the load instruction 312. In this example, the execution unit Ex₀-Ex_{N} will access a level 1 (L1) cache 340 at the address of the source register of the load instruction 312 to obtain the load data for executing the load instruction 312. The instruction cache 318 could be provided in the L1 cache 340 in one example. If the load data at the address of the source register of the load instruction 312 is not contained in the L1 cache 340, a cache miss occurs. A higher level cache memory(ies) 342 (e.g., a level 2 (L2) and/or level 3 (L3) cache), may then be accessed to obtain the load data at the address of the source register of the load instruction 312 before resorting to system memory 344 if all caches miss. However, in each of these cache miss scenarios, the dispatch circuit 336 may have already speculatively dispatched load-dependent instructions 312 that are dependent on the produced results of the load instruction 312. As discussed above, the scheduler circuit 304 is configured to “wake-up” instructions 312, including load-dependent instructions 312, to be dispatched once such instructions 312 no longer have register dependencies on non-dispatched instructions 312. However, if the load data for a load instruction 312 is not available, the register dependency of the dispatched load-dependent instructions 312 may not be resolved by the time the dispatched load-dependent instructions 312 are ready to be executed. Thus, the dispatched load-dependent instructions 312 will not properly execute, or the scheduler circuit 304 must be modified to not speculatively dispatch load-dependent instructions 312 until the load instructions 312 that produce their consumed results have executed. It is desired to be able to speculatively dispatch load-dependent instructions 312 to increase throughput efficiency of the instruction processing system 310.

In this regard, the scheduler circuit 304 in FIG. 3 is configured to perform a replay operation to re-dispatch load-dependent instructions 312 from a load instruction 312 that incurred a cache miss to load data during execution. In this manner, the load-dependent instructions 312 will execute once the produced data by the load instruction 312 as a result of obtaining the load data from memory is executed. In this regard, the execution circuit 322 is configured to issue a replay request 354 to the dispatch circuit 336 in response to a cache miss for obtaining load data for a load instruction 312 to be executed. The scheduler circuit 304 receives the replay request 354 which indicates the destination register R0-RP of the load operation of the load instruction 312 that incurred the cache miss. In this manner, the scheduler circuit 304 can cause any load-dependent instructions 312 that have a source register dependency on the register R0-RP indicated in the replay request 354 to be re-dispatched in a replay operation. However, the register dependency information 353 in the register dependency tracking circuit 352 for the load-dependent instructions 312 is needed for the instruction wake-up circuit 348 to know when the register dependencies of the load-dependent instructions 312 have been resolved to “wake up” and re-dispatch these load-dependent instructions 312.

In this regard, as will be discussed in more detail below, the scheduler circuit 304 in FIG. 3 also includes a shadow register dependency tracking circuit 356. The scheduler circuit 304 is configured to store shadow register dependency information 358 to the register dependency information 353 stored in the register dependency tracking circuit 352 for instructions 312 to be dispatched as they are stored in the register dependency tracking circuit 352. As discussed above, the register dependency tracking circuit 352 is configured to store the register dependency information 353 indicating if instructions 312 in the instruction list 346 are dependent on (i.e., consume) the produced results of other instructions 312 in the instruction list 346 yet to be dispatched according to their designation registers R0-RP. The shadow register dependency information 358 stored in the shadow register dependency tracking circuit 356 is not erased to remove register dependencies until the instructions 312 that produce results to the indicated register dependencies are executed. In this manner, in response to a replay operation, the scheduler circuit 304 can update the register dependency information 353 stored in the register dependency tracking circuit 352 from the shadow register dependency information 358 stored in the shadow register dependency tracking circuit 356, such that the restored register dependency information 353 for the load-dependent instructions 312 to be re-dispatched based on the register R0-RP indicated in the replay request 354 is available to the instruction wake-up circuit 348 to re-dispatch the load-dependent instructions 312.

Further, as will be discussed in more detail below, the scheduler circuit 304 includes an instruction valid circuit 360. The instruction valid circuit 360 contains instruction valid information 362 indicating if a load-dependent instruction 312 is ready to be replayed. The scheduler circuit 304 is configured to set the instruction valid information 362 to an invalid state for an instruction 312 that is not to be replayed. In response to the replay request 354, the scheduler circuit 304 is configured to set the instruction valid information 362 to a valid state in the instruction valid circuit 360 corresponding to the instruction 312 to be replayed that is dependent on the register R0-RP indicated in the replay request 354. The scheduler circuit 304 may use the instruction valid information 362 to control and cause the shadow register dependency information 358 in the shadow register dependency tracking circuit 356 to be updated in the register dependency information 353 in the register dependency tracking circuit 352 for the load-dependent instructions 312 to be replayed.

Further, as will be discussed in more detail below, the scheduler circuit 304 includes a replay circuit 364 that includes a load dependency tracking circuit 366. The load dependency tracking circuit 366 contains load dependency information 368 indicating the designation register R0-RP for load instructions 312 that are dispatched to be executed. A load instruction 312 scheduled to be dispatched in the scheduler circuit 304 is assigned a load instruction entry L₀-L_{X} in the load dependency tracking circuit 366. The load dependency tracking circuit 366 receives the replay request 354. The load dependency tracking circuit 366 uses the register information in the replay request 354 to determine the designation register R0-RP of the load instruction 312 that incurred a cache miss during execution of the load instruction 312. The load dependency information 368 corresponding to the register information from the replay request 354 is used to determine if there were any instructions 312 dispatched that were load-dependent on this destination register R0-RP for the load instruction 312 that incurred a cache miss. Based on the load dependency information 368, the load dependency tracking circuit 366 is configured to cause the scheduler circuit 304 to set the instruction valid information 362 to a valid state in the instruction valid circuit 360 corresponding to the instruction 312 to be replayed that is dependent on the register R0-RP indicated in the replay request 354. Based on the load dependency information 368, the load dependency tracking circuit 366 is also configured to cause the shadow register dependency information 358 in the shadow register dependency tracking circuit 356 to be updated in the register dependency information 353 in the register dependency tracking circuit 352 for the load-dependent instructions 312 to be replayed.

In this manner, the replay circuit 364 can use the load dependency tracking circuit 366 to determine which shadow register dependency information 358 in the shadow register dependency tracking circuit 356 is to be used to update the register dependency information 353 in the register dependency tracking circuit 352 in response to a replay operation. The load instruction 312 that incurred the cache miss is not used by the scheduler circuit 304 in this example to restore the load dependencies in the register dependency tracking circuit 352. Thus, the load instruction 312 does not have to be re-allocated in a reservation circuit to restore its register dependency information 353 in the register dependency tracking circuit 352, which would otherwise consume additional instruction space in the scheduler circuit 304 and require re-dispatching of the load instruction 312. In other words, a dispatched load instruction 312 can be de-allocated in a reservation circuit on its first dispatch, because the information needed to restore the register dependency information 353 of the load instruction 312 in the register dependency tracking circuit 352 can be obtained from the load dependency tracking circuit 366. Further, this allows load-dependent instructions 312 to be re-dispatched to consume the produced results from the load instruction 312 without waiting for the load instruction 312 to be re-dispatched and executed.

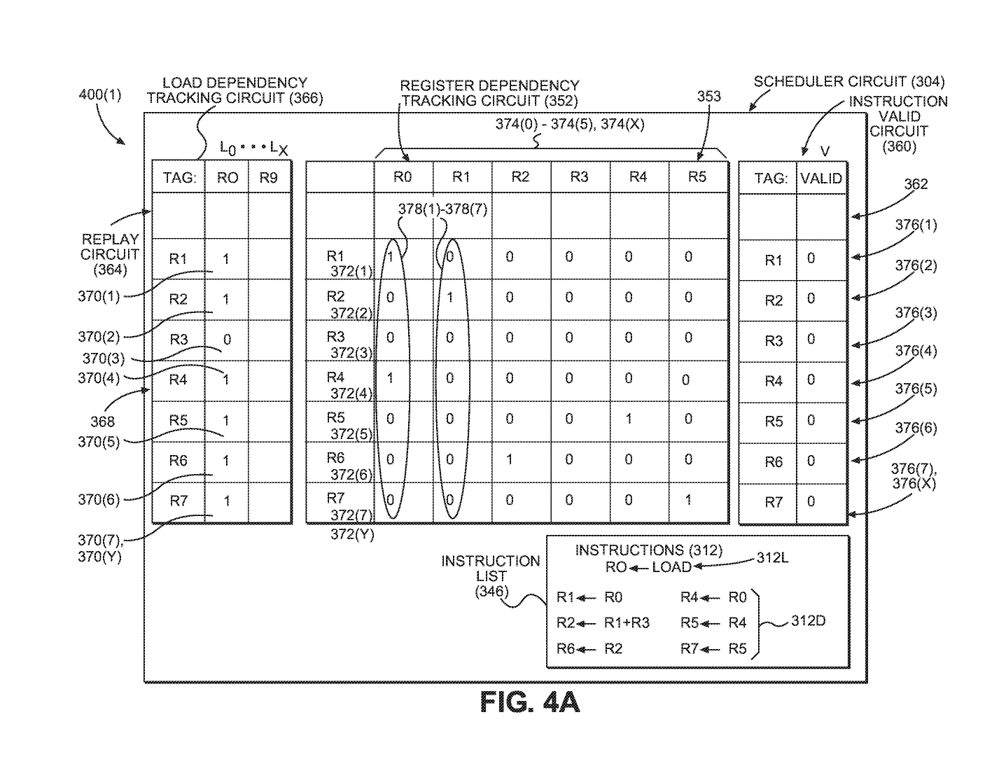

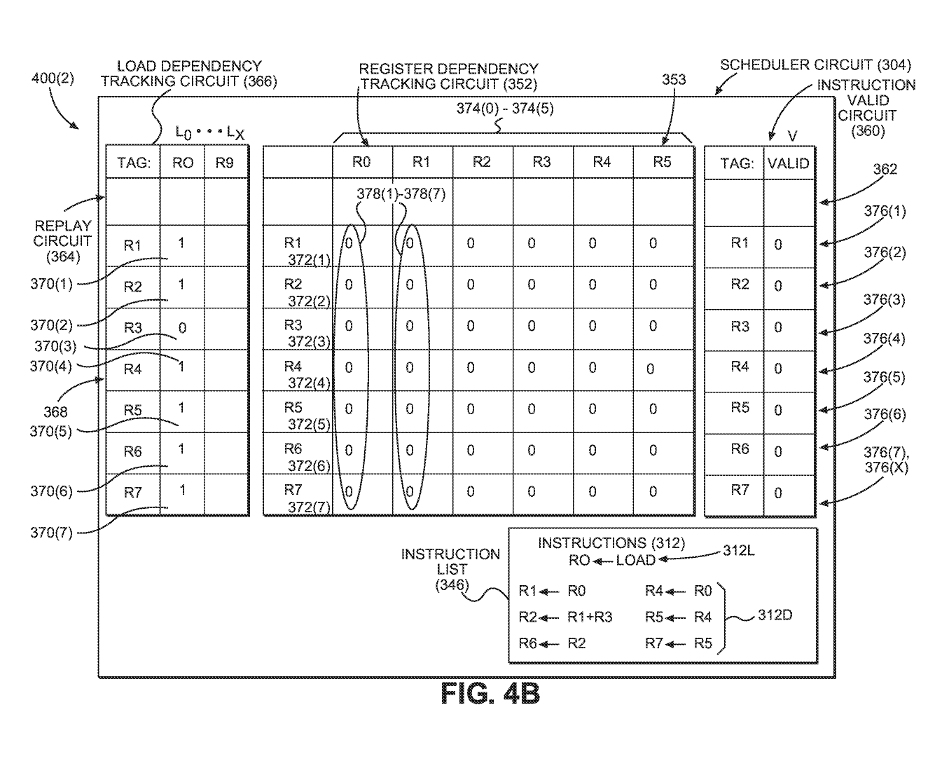

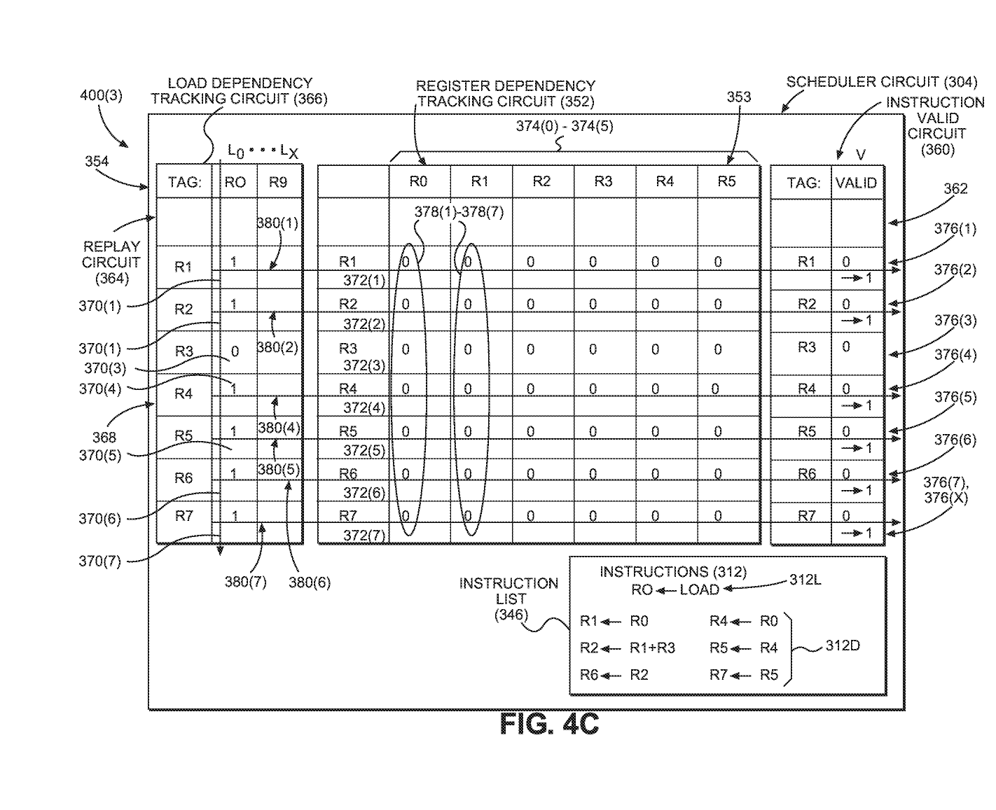

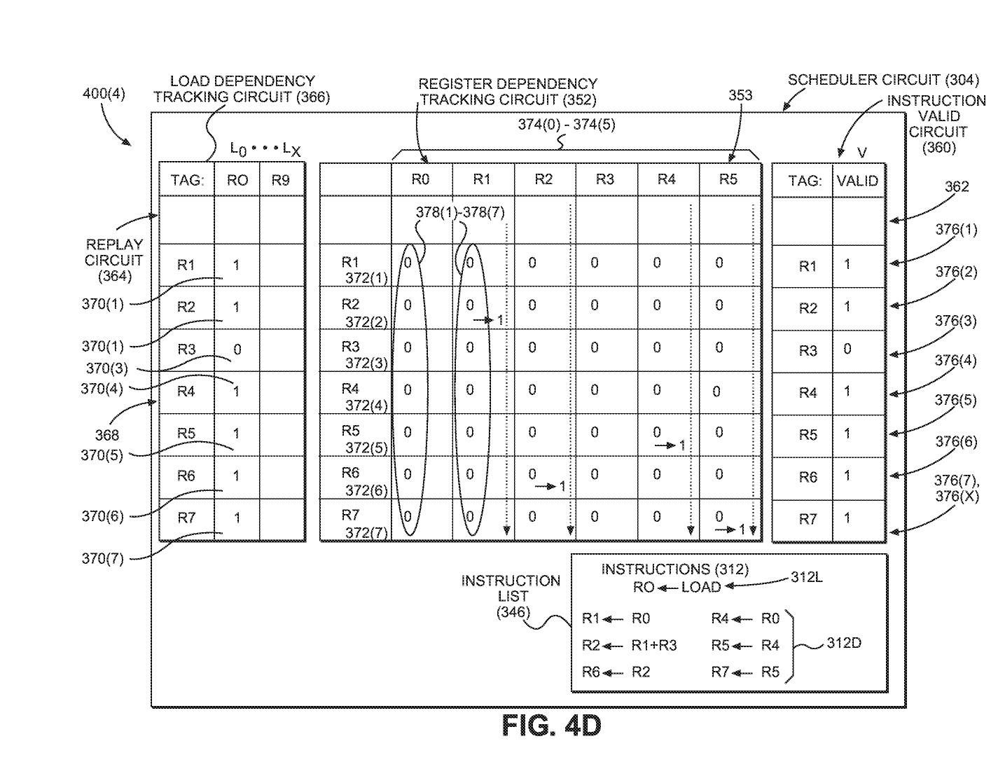

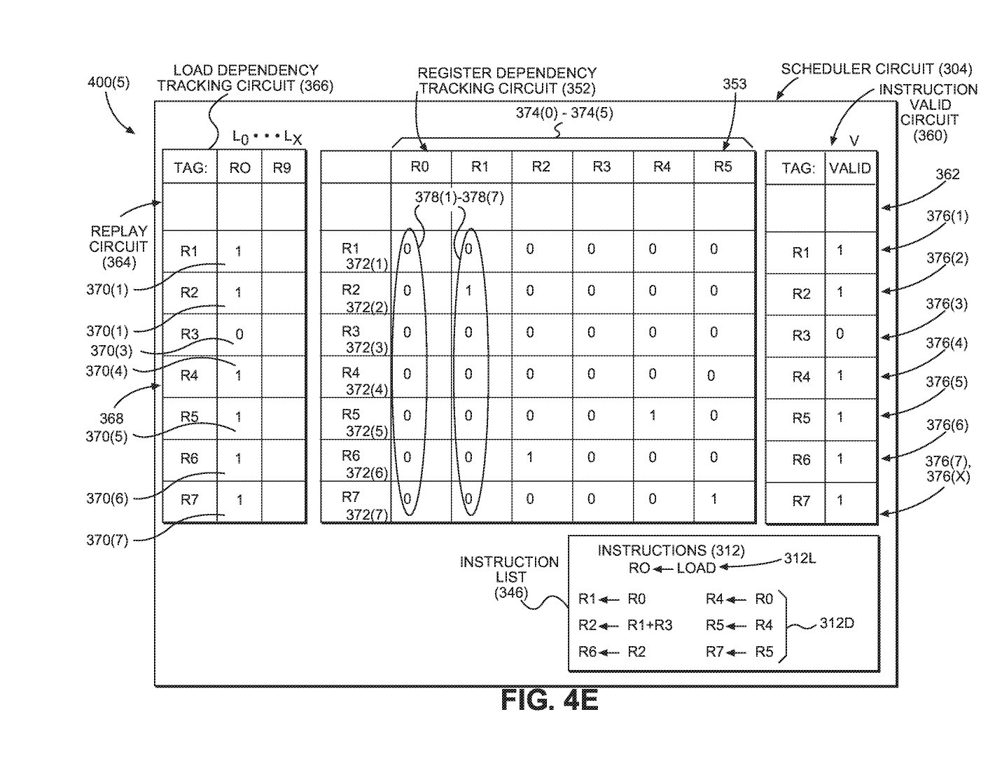

To further illustrate the register dependency tracking and replaying of load-dependent instructions 312 in the scheduler circuit 304 in the OoP 302 in FIG. 3, FIGS. 4A-4E are provided. FIGS. 4A-4E are logical diagrams illustrating exemplary register dependency tracking states in the scheduler circuit 304 in response to the scheduler circuit 304 speculatively dispatching load-dependent instructions 312 after dispatching of a load instruction 312, restoring register dependency information 353 for the load-dependent instructions 312, and replaying the load-dependent instructions 312 based on restored register dependencies in the scheduler circuit 304 for a replay operation.

FIG. 4A illustrates a logical diagram of an exemplary first state 400(1) of the load dependency tracking circuit 366, the register dependency tracking circuit 352, and the instruction valid circuit 360 in the scheduler circuit 304. The first state 400(1) is based on the instructions 312 in the instruction list 346 listed at the bottom of FIG. 4A before dispatching occurs. As shown therein, register R0 is a designation register for a load instruction 312L. Load-dependent instructions 312D are shown that each have either a direct or indirect register dependency on the load instruction 312L based on the destination register R0-RP of the load instruction 312L being register R0. The register dependencies are reflected in the load dependency tracking circuit 366. The load dependency tracking circuit 366 is configured to store the load dependency information 368 in a plurality of load instruction entries L₀-L_{X} that are configured to store load dependencies in the form of load dependency indicators 370(1)-370(7) for the registers in the OoP 302, shown as R1-R7 in this example. The number of load instruction entries entry L₀-L_{X} provided in the load dependency tracking circuit 366 may be based on the expected number of inflight load instructions 312L. Each load dependency indicator 370(1)-370(7) indicates a register load dependency state to a unique register among a plurality of registers R1-R7 in this example for a corresponding load instruction L₀-L_{X}. For example, load dependency bits in the load dependency indicators 370(1), 370(2), and 370(4)-370(7) are set to a dependency state, which is a logic ‘1’ state in this example, because registers R1, R2, and R4-R7 are directly or indirectly dependent on the produced results of the load instruction 312L R0←LOAD to source register R0. A no dependency state is a logic ‘0’ state in this example.

With continuing reference to FIG. 4A, the register dependency tracking circuit 352 in this example is configured to store the register dependency information 353 in a plurality of instruction entries 372(1)-372(7) corresponding to registers R1-R7 as destination registers. Each instruction entry 372(1)-372(7) contains a plurality of corresponding register dependency indicators 374(0)-374(5) to indicate a dependency state of an instruction 312 to be dispatched having source registers R0-R5. In this example, there are six (6) register dependency indicators 374(0)-374(5) corresponding to six (6) registers R0-R5, but note that any number (‘X’) of register dependency indicators 374(0)-374(X), may be provided. In this example, the register dependency indicators 374(0)-374(5) are register dependency bits that indicate register dependencies of instructions 312 corresponding to the instruction entries 372(1)-372(7), 372(Y). In this example, there are seven (7) instruction entries 372(1)-372(7), corresponding to seven (7) registers R1-R7, but note that any number (‘Y’) of instruction entries 372(1)-372(Y) may be provided. For example, instruction entry 372(1) corresponds to instructions 312 that have a designation register of R0. Instruction entry 372(2) corresponds to instructions 312 that have a destination register of R1, and so on. The register dependency indicator 374(0) is set to a dependency state (‘1’) for instruction entry 372(1) to indicate that the instruction R1←R0 has a source register dependency on register R0, which is a direct register dependency from load instruction 312L. Register dependency indicator 374(4) is set to a dependency state (‘1’) for instruction entry 372(5) to indicate that the instruction R5←R4 has a source register dependency on register R4, which has a register dependency on register R0 by instruction R4←R0. Thus, instruction R5←R4 has an indirect register dependency on load instruction 312L R0←LOAD. In this example, the instruction wake-up circuit 348 in the scheduler circuit 304 in FIG. 3 is configured to update the dependency state of the register dependency indicators 374(0)-374(5) in the instruction entries 372(1)-372(7) in the register dependency tracking circuit 352, corresponding to register dependency information 353 of the load-dependent instructions 312D to be dispatched.

With continuing reference to FIG. 4A, the instruction valid circuit 360 in this example is configured to store the instruction valid information 362 in a plurality of instruction valid entries 376(1)-376(7) each configured to store a corresponding instruction valid indicator 378(1)-378(7) corresponding to an instruction entry 372(1)-372(7) in the register dependency tracking circuit 352. The instruction valid indicators 378(1)-378(7) are bits in this example that can be set to a valid state (‘1’ in this example) indicating that the load-dependent instruction 312D having a source register R corresponding to an instruction entry 372(1)-372(7) in a dependency state in the register dependency tracking circuit 352 is to be replayed and re-dispatched. The instruction valid indicators 378(1)-378(7) are set to an invalid state (‘0’ in this example) indicating that the load-dependent instruction 312D having a source register R corresponding to an instruction entry 372(1)-372(7) in a no dependency state in the register dependency tracking circuit 352 is not to be replayed, because the load instruction 312 has not yet been dispatched in this first state 400(1) in FIG. 4A to be executed. Thus, it is not known if a cache miss will occur when loading in load data for execution of the load instruction 312L in the execution circuit 322 (FIG. 3).

Note that in FIG. 4A, the load dependency indicators 370(1)-370(7) for the load instruction entries L₀-L_{X}, the register dependency indicators 374(0)-374(5) for the instruction entries 372(1)-372(7), and the instruction valid entries 376(1)-376(7) are shown in sequential columns in their respective load dependency tracking circuit 366, register dependency tracking circuit 352, and instruction valid circuit 360. However, note that such a sequential organization is not required. The load dependency indicators 370(1)-370(7), the register dependency indicators 374(0)-374(5) for the instruction entries 372(1)-372(7), and the instruction valid entries 376(1)-376(7) could be stored in the scheduler circuit 304 in any order desired. The respective load dependency tracking circuit 366, register dependency tracking circuit 352, and instruction valid circuit 360 may include statically assigned storage cells for the storage of their respective register dependency indicators 374(0)-374(5) for the instruction entries 372(1)-372(7), and the instruction valid entries 376(1)-376(7), or use an allocation scheme for storage.

FIG. 4B is a logical diagram illustrating an exemplary second state 400(2) of the load dependency tracking circuit 366, the register dependency tracking circuit 352, and the instruction valid circuit 360 in the scheduler circuit 304. The second state 400(2) is based on the instructions 312 in the instruction list 346 listed at the bottom of FIG. 4B being dispatched by the scheduler circuit 304. As shown in FIG. 4B, all the register dependency indicators 374(0)-374(5) for the instruction entries 372(1)-372(7) in the register dependency tracking circuit 352 are cleared by the scheduler circuit 304 to the no dependency state. However, the load dependency information 368 is still retained in the load dependency indicators 370(1)-370(7) for the load instruction entries L₀-L_{X} in the load dependency tracking circuit 366 in case the register dependency indicators 374(0)-374(5) for the instruction entries 372(1)-372(7) in the register dependency tracking circuit 352 need to be restored for replaying the load-dependent instructions 312D in the event of a cache miss during execution of the load instruction 312L. As will be discussed below, the load dependency tracking circuit 366 is configured to cause the shadow register dependency tracking circuit 356, shown in FIG. 3, to restore the dependency states of the register dependency indicators 374(0)-374(5) for the instruction entries 372(1)-372(7) in the register dependency tracking circuit 352 in response to the replay request 354 based on the load dependency indicators 370(1)-370(7) for the load instruction entries L₀-L_{X} in the load dependency tracking circuit 366.

FIG. 4C is a logical diagram illustrating an exemplary third state 400(3) of the load dependency tracking circuit 366, the register dependency tracking circuit 352, and the instruction valid circuit 360 in the scheduler circuit 304. The third state 400(3) is based on the load data for the load instruction 312L incurring a cache miss when being executed in the execution circuit 322. As shown in FIG. 4C, the scheduler circuit 304 uses the load dependency information 368 in load dependency indicators 370(1)-370(2) and 370(4)-370(7) for the load instruction entries L₀-L_{X} in the load dependency tracking circuit 366 to cause the corresponding instruction valid entries 376(1)-376(2), 376(4)-376(7) to be changed from an invalid state (‘0’) to a valid state (‘1’), meaning that the corresponding load-dependent instructions 312D that are load-dependent on the load instruction 312L are to be replayed. In this example, the replay circuit 364 is configured to generate and broadcast a corresponding replay command 380(1)-380(2), 380(4)-380(7) based on the load dependency indicators 370(1)-370(2), 370(4)-370(7) that are set to the dependency state (‘1’) in the load dependency tracking circuit 366. The load dependency information 368 is known for the load instruction 312L, because as discussed above, the load dependency information 368 in the load dependency indicators 370(1)-370(2), 370(4)-370(7) for the load instruction entries L₀-L_{X} in the load dependency tracking circuit 366 after the load instruction 312L and its load-dependent instructions 312D is dispatched. In this example, a replay command 380(3) is not generated by the load dependency tracking circuit 366, because register R3 is not dependent on a production from an instruction 312 that is directly or indirectly register dependent on the load instruction 312L. Replay commands 380(1)-380(2) and 380(4)-380(7) are generated by the replay circuit 364, because registers R1-R2, and R4-R7 are source registers in the load-dependent instructions 312D and are directly or indirectly register dependent on the load instruction 312L. Thus, providing the load dependency tracking circuit 366 allows the register dependency information 353 in the register dependency tracking circuit 352 to be restored so that the load-dependent instructions 312D can be replayed, and without having to re-allocate and re-dispatch the load instruction 312L. The load instruction 312L can remain in the execution circuit 322 to be executed when its load data comes back from memory.

FIG. 4D is a logical diagram illustrating an exemplary fourth state 400(4) of the load dependency tracking circuit 366, the register dependency tracking circuit 352 and the instruction valid circuit 360 in the scheduler circuit 304 that follows the third state 400(3) in FIG. 4C. As shown in FIG. 4D, the instruction valid entries 376(1)-376(2), 376(4)-376(7) corresponding to the load dependency information 368 in load dependency indicators 370(1)-370(2), 370(4)-370(7) for the load instruction entries L₀-L_{X} in the load dependency tracking circuit 366 are changed to the valid state (‘1’). The replay circuit 364 generating the replay commands 380(1)-380(2), 380(4)-380(7) in response to the load dependency states in the load dependency indicators 370(1)-370(2), 370(4)-370(7) also causes dependency states in the register dependency indicators 374(0)-374(5) for the instruction entries 372(1)-372(7) corresponding to the load-dependent instructions 312D to be restored, which is the same dependency state as shown in FIG. 4A. In this regard, the generation of the replay commands 380(1)-380(2), 380(4)-380(7) by the replay circuit 364 based on the load dependency tracking circuit 366 causes the shadow register dependency tracking circuit 356, to restore the shadow dependency states to the register dependency indicators 374(0)-374(5) for the instruction entries 372(1)-372(2), 372(4)-372(7) in the register dependency tracking circuit 352 based on the load dependency indicators 370(1)-370(2), 370(4)-370(7) for the load instruction entries L₀-L_{X} in the load dependency tracking circuit 366. For example, the shadow register dependency tracking circuit 356 may be organized like the register dependency tracking circuit 352 to store the shadow register dependency information 358.

FIG. 4E is a logical diagram illustrating an exemplary fifth state 400(5) of the load dependency tracking circuit 366, the register dependency tracking circuit 352 and the instruction valid circuit 360 in the scheduler circuit 304 that follows the fourth state 400(4) in FIG. 4D. As shown in FIG. 4E, the instruction valid entries 376(1), 376(2), 376(4)-376(7) corresponding to the load dependency information 368 in the load dependency indicators 370(1)-370(2), 370(4)-370(7) for the load instruction entries L₀-L_{X} in the load dependency tracking circuit 366 remain in the valid state (‘1’). The register dependency indicators 374(1)-374(2), 374(4)-374(5) for the instruction entries 372(1)-372(2), 372(4)-372(7) in the register dependency tracking circuit 352 based on the load dependency indicators 370(1)-370(2), 370(4)-370(7) for the load instruction entries L₀-L_{X} in the load dependency tracking circuit 366 are restored from the shadow register dependency tracking circuit 356. The register dependency tracking circuit 352 is now configured such that the scheduler circuit 304 can replay the load-dependent instructions 312D to be re-dispatched in order of their original dependencies before the load-dependent instructions 312D and the load instruction 312L were dispatched. In this example, note that the register dependency indicator 374(0) for register R0 for the instruction entries 372(1)-372(7) is ‘0’ in FIG. 4E, meaning no dependency exists, because the load instruction 312L does not have to be re-dispatched to be executed in response to load cache miss. As discussed above, the load instruction 312L is executed in the execution circuit 322 (FIG. 3) and only its load-dependent instructions 312D need to be re-dispatched. Thus, the register dependency indicator 374(0) for register R0 for the instruction entries 372(1)-372(7) does not have to be restored for a replay operation.

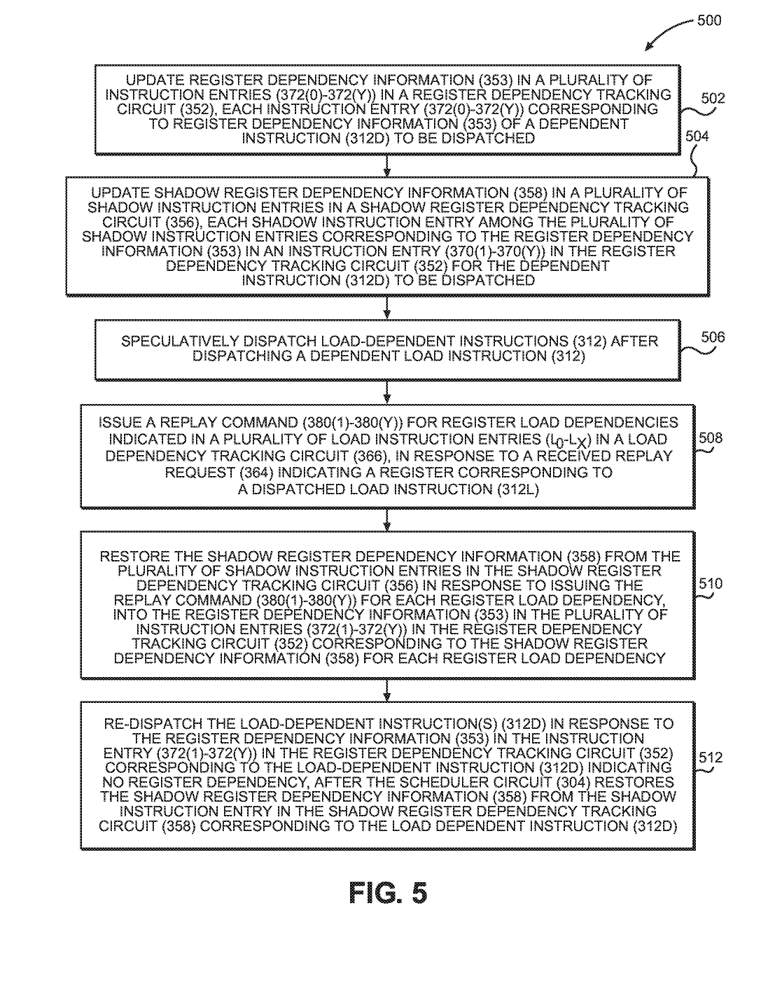

FIG. 5 is a flowchart illustrating an exemplary process 500 of the scheduler circuit 304 in FIG. 3 speculatively dispatching load-dependent instructions 312 after dispatching a load instruction 312 and replaying the load-dependent instructions 312 based on restored register dependencies in the scheduler circuit 304 for a replay operation. The process 500 in FIG. 5 is discussed in regard to the OoP 302 in FIG. 3 and the exemplary scheduler circuit 304 in FIGS. 4A-4E. As instructions 312 are received and allocated in the dispatch circuit 336, the scheduler circuit 304 updates the register dependency information 353 in the instruction entries 372(1)-372(Y) in the register dependency tracking circuit 352, wherein each instruction entry 372(1)-372(Y) corresponds to register dependency information 353 of a dependent instruction 312D to be dispatched (block 502 in FIG. 5). The scheduler circuit 304 also updates corresponding shadow register dependency information 358 in the instruction entries in the shadow register dependency tracking circuit 356 with the register dependency information 353 of a dependent instruction 312D to be dispatched (block 504 in FIG. 5). In this manner, the shadow register dependency tracking circuit 356 retains the register dependency information 353 of dispatched dependent instruction 312D until their dependent instruction 312, such as a load instruction 312L is executed. The scheduler circuit 304 also speculatively dispatches one or more load-dependent instructions 312 after a dependent load instruction 312 (block 506 in FIG. 5). The scheduler circuit 304 also updates the register dependency information 353 in the instruction entries 372(0)-372(Y) (block 502), and the corresponding shadow register dependency information 358 in the instruction entries in the shadow register dependency tracking circuit 356 with the register dependency information 353 of the dependent instruction 312D (block 504) as a result of dispatching and speculatively dispatching in block 506.

With continuing reference to FIG. 5, in response to a replay request 354 received from the execution circuit 322 indicating a source register for a dispatched load instruction 312, which is generated in response to a cache miss to obtain load data for execution of a load instruction 312L, the scheduler circuit 304, and particularly the replay circuit 364, issues a replay command 380(1)-380(Y) for register load dependencies indicated in the load instruction entries L₀-L_{X} in the load dependency tracking circuit 366 (block 508 in FIG. 5). The scheduler circuit 304 restores the shadow register dependency information 358 from the plurality of shadow instruction entries in the shadow register dependency tracking circuit 356 in response to the replay command 380(1)-380(Y) issued by the replay circuit 364 for each register load dependency, into the register dependency information 353 in the plurality of instruction entries 372(1)-372(Y) in the register dependency tracking circuit 352 corresponding to the shadow register dependency information 358 for each register load dependency (block 510 in FIG. 5). The scheduler circuit 304 then re-dispatches the load-dependent instruction(s) 312D in response to the register dependency information 353 in the instruction entry 372(1)-372(Y) in the register dependency tracking circuit 352 corresponding to the load-dependent instruction 312D indicating no register dependency, after the scheduler circuit 304 restores the shadow register dependency information 358 from the shadow instruction entry in the shadow register dependency tracking circuit 356 corresponding to the load-dependent instruction 312D (block 512 in FIG. 5).

The replay circuit 364, the instruction wake-up circuit 348, and the instruction valid circuit 360 in the scheduler circuit 304 in FIG. 3 can be provided in different designs. For example, as discussed above, the load dependency tracking circuit 366 in the replay circuit 364 can be configured to store all the dependencies of a dispatched load instruction 312. In this manner, the load dependency tracking circuit 366 can be configured to issue the replay commands 380(1)-380(Y) for all the dependencies of the load instruction entries L₀-L_{X}. This causes the scheduler circuit 304 to restore the shadow register dependency information 358 in the shadow register dependency tracking circuit 356 for each direct and indirect register load dependency in the register dependency tracking circuit 352.

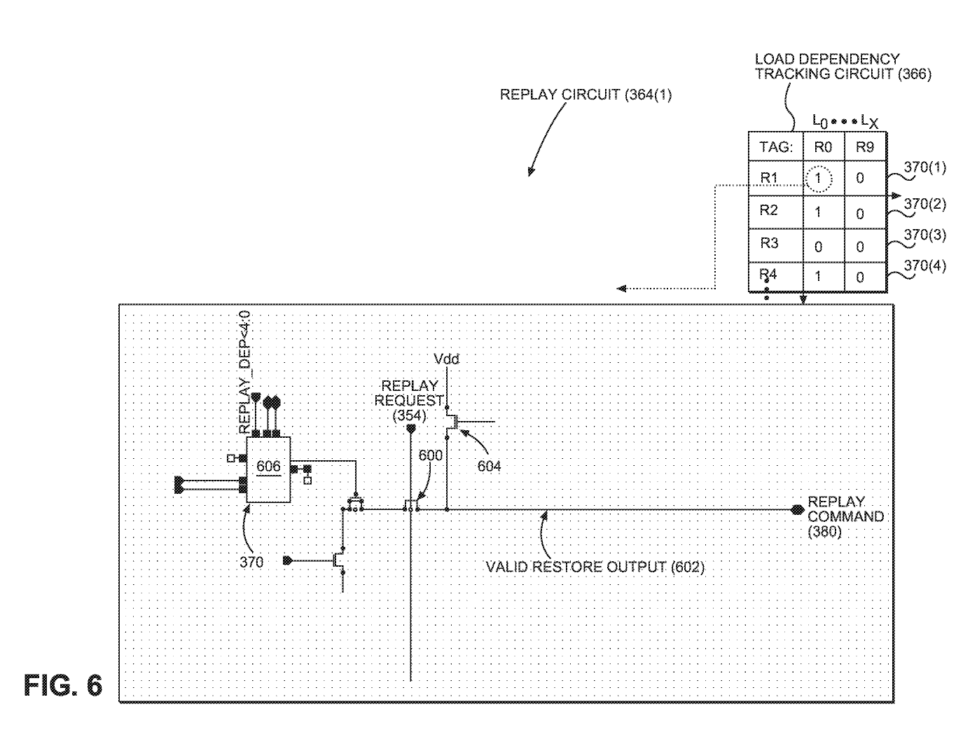

In this regard, FIG. 6 is a schematic diagram of an exemplary replay circuit 364(1) that can be provided each load instruction entry L₀-L_{X} for the load instruction entries L₀-L_{X} in the scheduler circuit 304 in FIG. 3. The replay circuit 364(1) in FIG. 6 is configured to store a register dependency from a dispatched load instructions 312L and issuing a corresponding replay command 380 to initiate a replay operation in response to a cache miss for the dispatched load instruction 312L. The replay circuit 364(1) shown in FIG. 6 is for only one load instruction entry L₀-L_{X} in the scheduler circuit 304. However, note that multiple of the replay circuits 364(1) can be provided for the load instruction entries L₀-L_{X} for storing a register dependency from a dispatched load instruction 312L and issuing a corresponding replay command 380 (shown as replay command 380(1)-380(7) in FIG. 4C for example). In this regard, the replay circuit 364(1) is configured to receive a replay request 354 from the execution circuit 322 in response to a cache miss for loading data for execution of a dispatched load instruction 312L. In response to the replay request 354, a discharge circuit 600 is configured to discharge a valid restore output 602 to a stored dependency state of a load dependency indicator 370 stored in a storage circuit 606, such as load dependency indicator 370(1) for load instruction entry L₀ as shown in FIG. 6. The valid restore output 602 was previously pre-charged to a supply voltage Vdd by a pre-charge circuit 604 in a pre-charge phase. The stored dependency state of the load dependency indicator 370 for each of the load instruction entries L₀-L_{X} in the storage circuit 606 is evaluated by an evaluation circuit in an evaluation phase to control the state of the valid restore output 602.

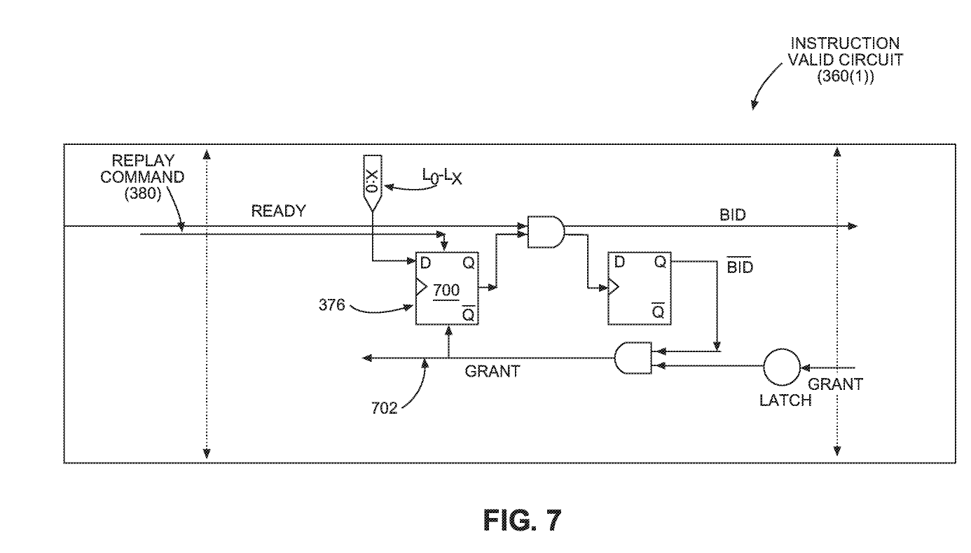

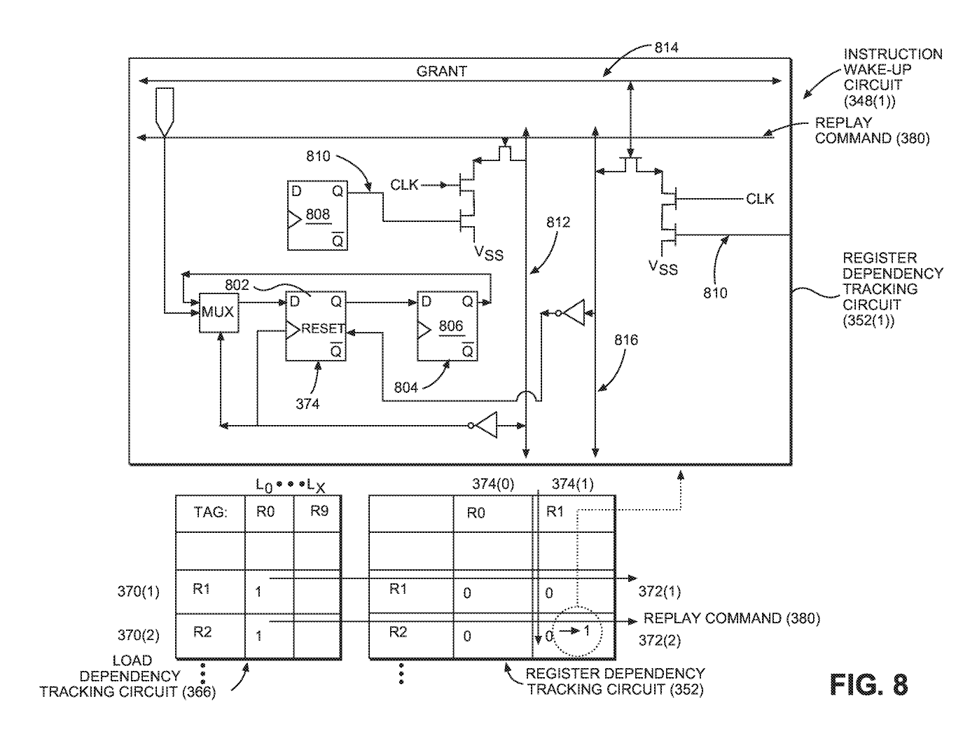

FIG. 7 is a schematic diagram of an exemplary instruction valid circuit 360(1) that can be provided for each instruction valid entry 376(1)-376(X) in the scheduler circuit 304 in FIG. 3. The instruction valid circuit 360(1) is configured to store and restore a corresponding instruction valid entry 376 associated with load-dependent instructions 312D to be replayed, in response to the replay circuit 364(1) in FIG. 6 issuing the replay command 380 for a replay operation. As shown in FIG. 8, the instruction valid circuit 360(1) includes a storage circuit 700 in the form of a flip-flop to provide the instruction valid entry 376. The storage circuit 700 is configured to store the valid state for the instruction valid entry 376. The storage circuit 700 is configured to latch a valid state based on the load dependencies indicated by the load instruction entries L₀-L_{X} in the replay circuit 364(1) in FIG. 6, in response to the replay command 380 issued by the replay circuit 364(1). The valid state stored in the storage circuit 700 is used to control issuing a grant 702 to allow the corresponding load-dependent instructions 312D to be dispatched.

FIG. 8 is a schematic diagram of an exemplary register dependency indicator 374 for a register dependency tracking circuit 352(1) that can be included in the scheduler circuit 304 in FIG. 3. The register dependency tracking circuit 352(1) may be part of an instruction wake-up circuit 348(1) that can be provided in the scheduler circuit 304 in FIG. 3 for restoring register dependencies for a dispatched load instruction 312L in response to the replay circuit 364(1) in FIG. 6 issuing a replay command 380 in response to a replay operation. In this regard, the register dependency tracking circuit 352(1) is configured to receive the replay command 380 from the replay circuit 364(1) in FIG. 6 for the register dependency indicator 374. In response, a storage circuit 802 in the form of a flip-flop is provided as the register dependency indicator 374 configured to latch a dependency state. The latched dependency state is also provided to a shadow register dependency indicator 804 that is provided as a storage circuit 806 in the form of a flip-flop. Thus in this manner, the shadow register dependency indicator 804 shadow stores the register dependency stored in the register dependency indicator 374. A broadcast storage circuit 808 provided in the form of a flip-flop is configured to drive a restore output 810 to cause the replay command 380 to drive a restore command 812 to cause the register dependency indicator 374 and the shadow register dependency indicator 804 to latch the register dependency information 353 for a load-dependent instruction 312D. A grant 814 issued by the picker circuit 350 in FIG. 3 when dispatching an instruction 312 corresponding to the register dependency indicator 374 is configured to assert a grant 814 on a grant line 816 to reset and clear out the register dependency information 353 in the register dependency indicator 374, but not the shadow register dependency indicator 804. The register dependency information 353 in the shadow register dependency indicator 804 is retained even when the instruction 312 corresponding to the register dependency indicator 374 is dispatched.

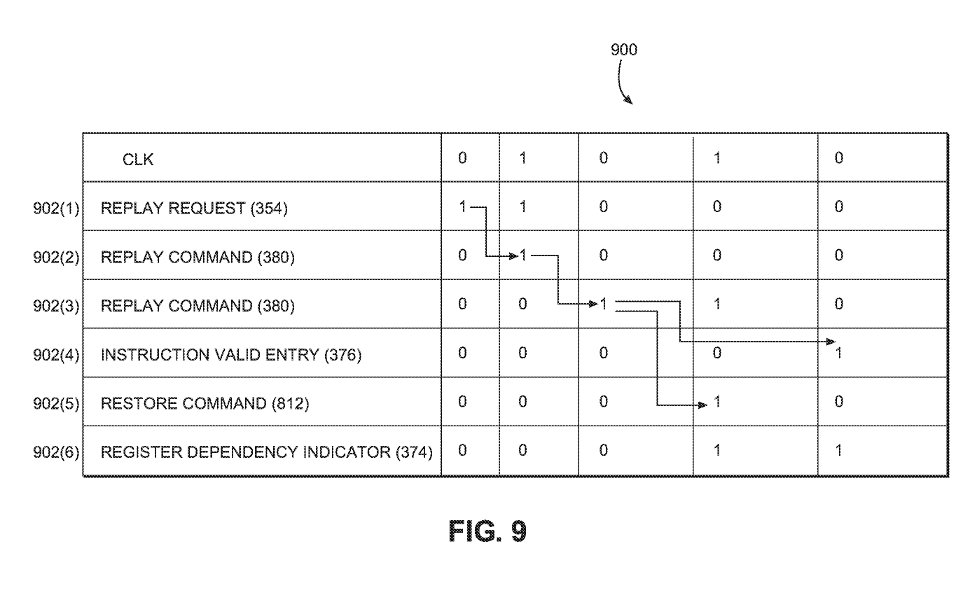

To summarize FIGS. 4A-8, FIG. 9 is a timing diagram 900 illustrating an exemplary time sequence 902(1)-902(6) of signals generated in the replay circuit 364(1) in FIG. 6, the instruction valid circuit 360(1) in FIG. 7, and the instruction wake-up circuit 348(1) in FIG. 8, in response to a clock signal CLK. The generation of signals in the time sequence 902(1)-902(6) restores direct and indirect register dependencies in the register dependency tracking circuit 352 in response to a replay request 354 in response to a cache miss for a load instruction 312L, for replaying the dispatch of load-dependent instructions 312D for a replay operation. As shown in FIG. 9, in response to a replay request 354 in time sequence 902(1), a replay command 380 is generated by the replay circuit 364(1) in FIG. 6 in time sequence 902(2) based on the register dependency indicated in the replay request 354 for the dependent load instruction 312 that incurred a load cache miss. In response, in time sequence 902(3), the replay command 380 is received by the instruction valid circuit 360(1) in FIG. 7. In response, an instruction valid entry 376 corresponding to the replay command 380 is updated in the instruction valid circuit 360(1) in time sequence 902(4). In response to updating the instruction valid entry 376, a corresponding restore command 812 is issued by the instruction wake-up circuit 348(1) in FIG. 8 in time sequence 902(5). This causes the shadow register dependency indicator 804 in FIG. 8 for the shadow register dependency tracking circuit 356 (see FIG. 3) to restore the register dependency indicator 374 in the register dependency tracking circuit 352(1) in time sequence 902(6) so that the corresponding load-dependent instruction 312D will be re-dispatched.

As shown and discussed above in FIGS. 4A-4E, the scheduler circuit 304 in FIG. 3 can be configured restore the register dependency information 353 in the register dependency tracking circuit 352 for both direct and indirect load-dependent instructions 312D in response to the same restore operations. However, the register dependency information 353 for indirect load-dependent instructions 312D is not needed before the register dependency information 353 is needed for the direct load-dependent instructions 312D, because the direct load-dependent instructions 312D are dispatched before the indirect load-dependent instructions 312D. Thus, the scheduler circuit 304 can be configured to sequence the restoring of the register dependency information 353 in the register dependency tracking circuit 352 based on the dependency hierarchy of the load-dependent instructions 312D in response to the replay request 354.

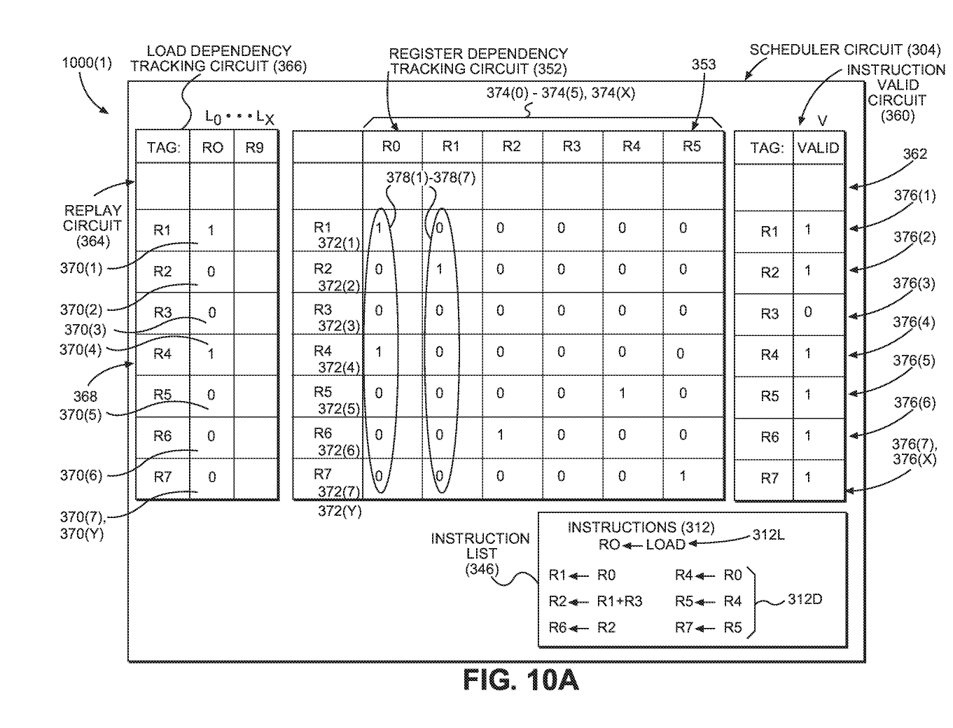

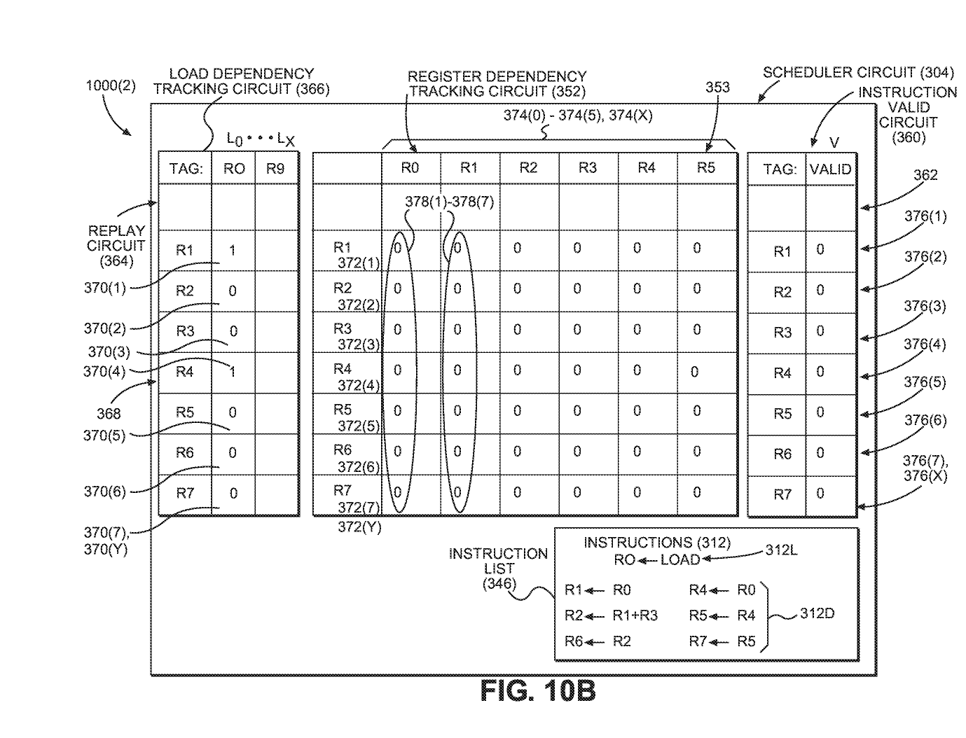

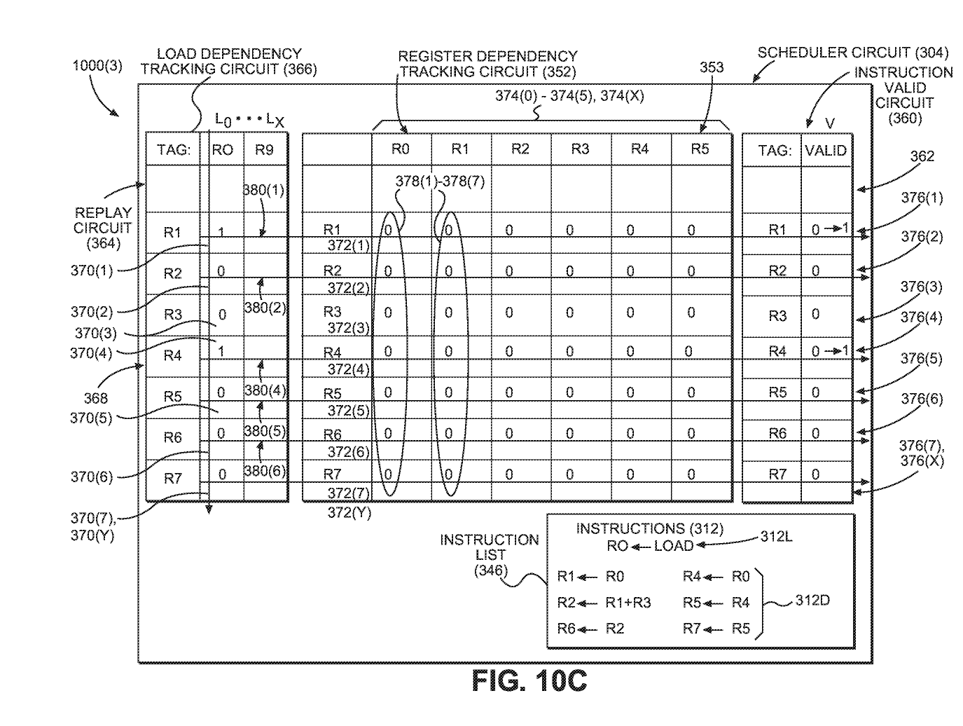

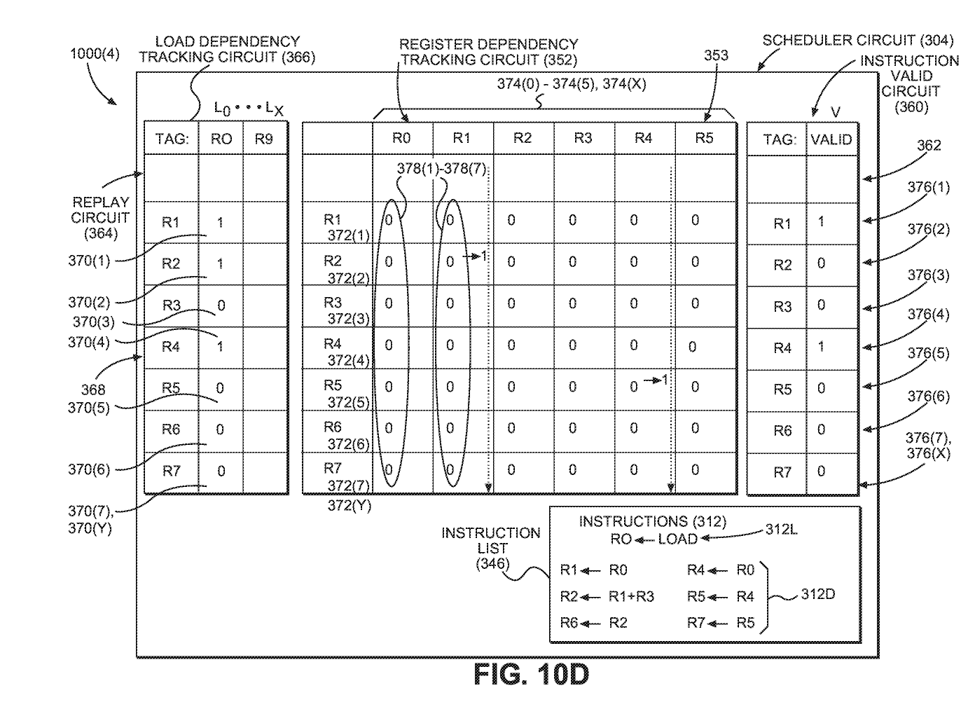

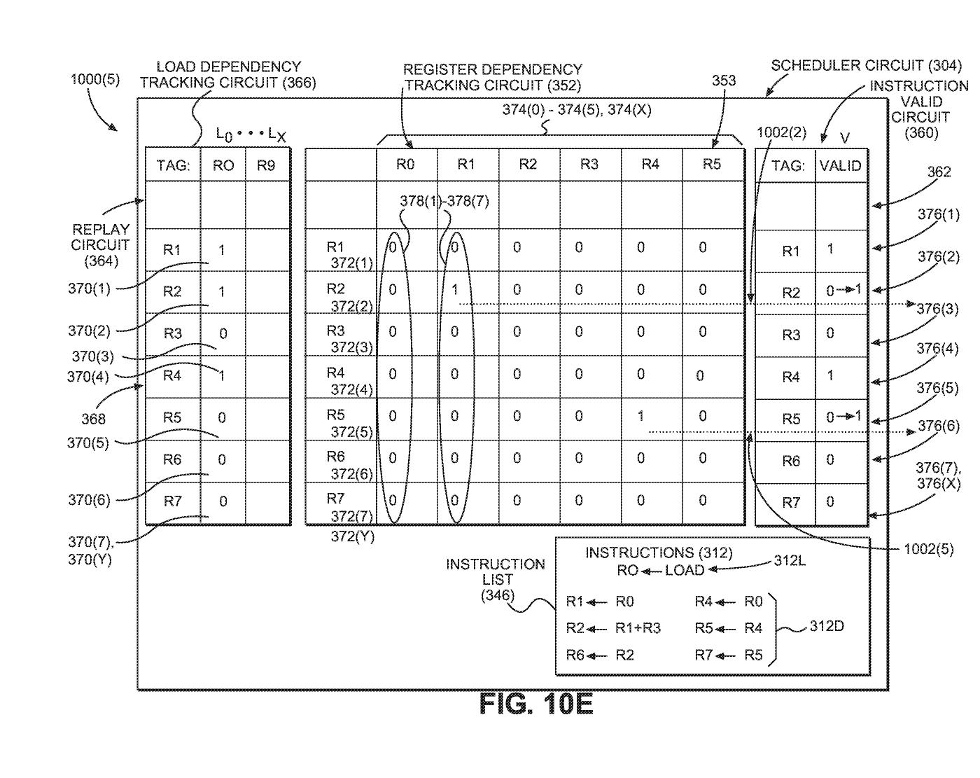

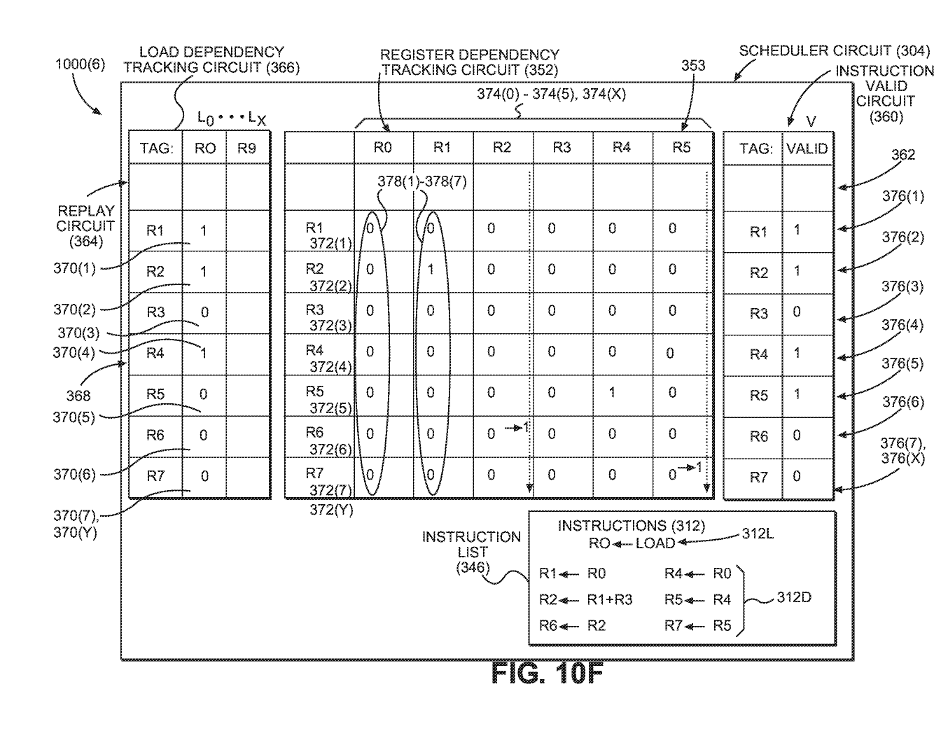

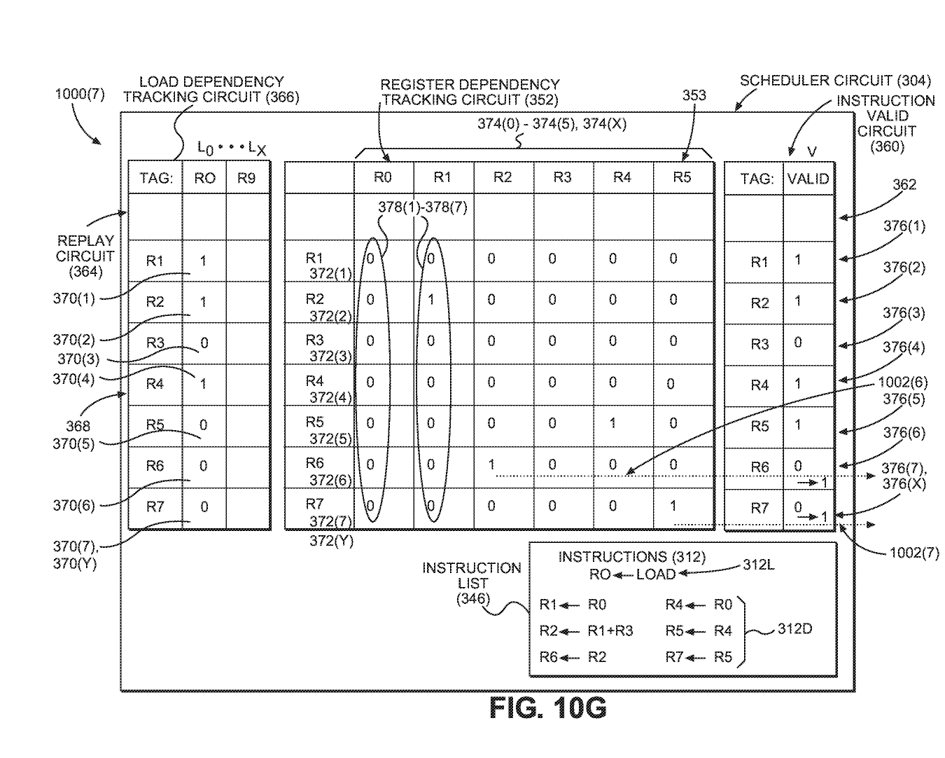

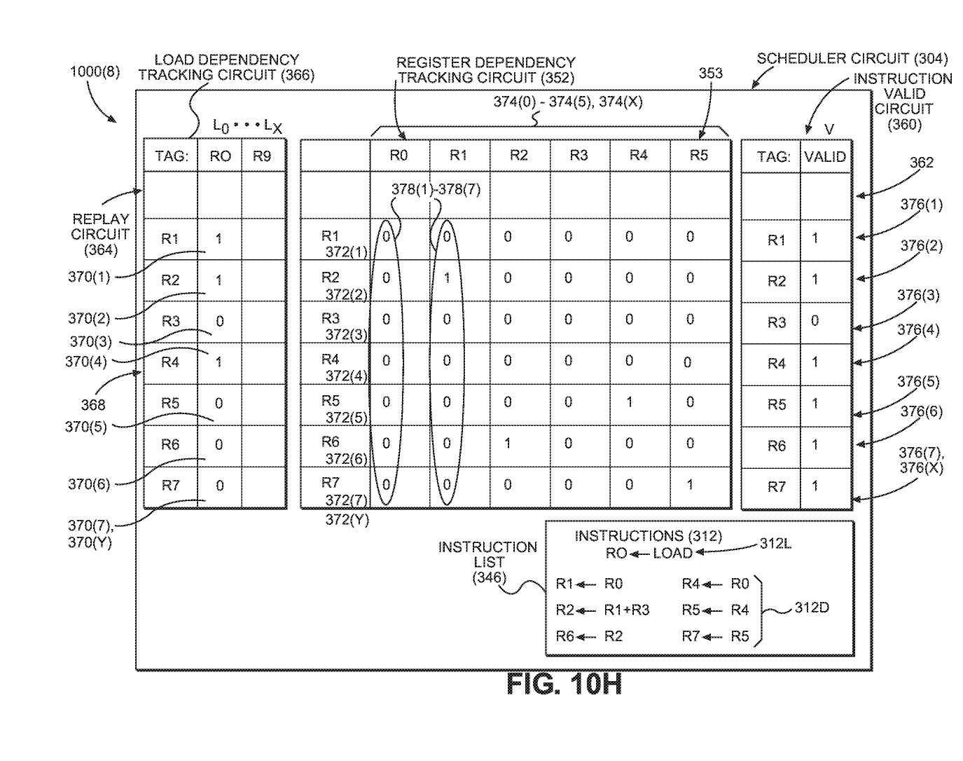

In this regard, FIGS. 10A-10H are logical diagrams illustrating exemplary register dependency tracking states in the scheduler circuit 304 in response to the scheduler circuit 304 speculatively dispatching load-dependent instructions 312 after dispatching of a load instruction 312, restoring register dependency information 353 in the scheduler circuit 304, and replaying the load-dependent instructions 312 based on restored register dependencies in the scheduler circuit 304 for a replay operation. Common elements between the FIGS. 10A-10H and FIGS. 4A-4E are shown with common elements and thus may not be re-described.

FIG. 10A is a logical diagram illustrating an exemplary first state 1000(1) of the load dependency tracking circuit 366, the register dependency tracking circuit 352, and the instruction valid circuit 360 in the scheduler circuit 304. The first state 1000(1) is based on the instructions 312 in the instruction list 346 listed at the bottom of FIG. 10A before dispatching occurs. As shown therein, register R0 is a designation register for a load instruction 312L. Load-dependent instructions 312D are shown that each have either a direct or indirect register dependency on the load instruction 312L based on the destination register R of the load instruction 312L being register R0. In this example, unlike as shown in FIG. 4A, only direct register dependencies are stored by the replay circuit 364 in the load dependency tracking circuit 366. The load dependency tracking circuit 366 is configured to store the direct load dependency information 368 in a plurality of load instruction entries L₀-L_{X} that are configured to store load dependencies in the form of load dependency indicators 370(1)-370(7) for the registers in the OoP 302, shown as R1-R7 in this example. For example, only load dependency bits in the load dependency indicators 370(1) and 370(4)-370(7) are set to a dependency state, which is a logic ‘1’ state in this example, because only registers R1 and R4 are directly dependent on the produced results of the load instruction 312L R0←LOAD to source register R0.

With continuing reference to FIG. 10A, the register dependency tracking circuit 352 stores the register dependency information 353 in a plurality of instruction entries 372(1)-372(7), 372(X) corresponding to registers R1-R7 as destination registers. In this example, there are six (6) register dependency indicators 374(0)-374(5), corresponding to six (6) registers R0-R5, but note that any number (‘X’) of register dependency indicators 374(0)-374(X), may be provided. Also in this example, there are seven (7) instruction entries 372(1)-372(7), corresponding to seven (7) registers R1-R7, but note that any number (‘Y’) of instruction entries 372(1)-372(7) may be provided. The instruction valid circuit 360 stores the instruction valid information 362 in a plurality of instruction valid entries 376(1)-376(7) each configured to store a corresponding instruction valid indicator 378(1)-378(7) corresponding to an instruction entry 372(1)-372(7) in the register dependency tracking circuit 352.

Note that in FIG. 10A, the load dependency indicators 370(1)-370(7) for the load instruction entries L₀-L_{X}, the register dependency indicators 374(0)-374(5) for the instruction entries 372(1)-372(7), and the instruction valid entries 376(1)-376(7) are shown in sequential columns in their respective load dependency tracking circuit 366, register dependency tracking circuit 352, and instruction valid circuit 360. However, note that such a sequential organization is not required. The load dependency indicators 370(1)-370(7), the register dependency indicators 374(0)-374(5) for the instruction entries 372(1)-372(7), and the instruction valid entries 376(1)-376(7) could be stored in the scheduler circuit 304 in any order desired. The respective load dependency tracking circuit 366, register dependency tracking circuit 352, and instruction valid circuit 360 may include statically assigned storage cells for the storage of their respective register dependency indicators 374(0)-374(5) for the instruction entries 372(1)-372(7), and the instruction valid entries 376(1)-376(7), or use an allocation scheme for storage.

FIG. 10B is a logical diagram illustrating an exemplary second state 1000(2) of the load dependency tracking circuit 366, the register dependency tracking circuit 352, and the instruction valid circuit 360 in the scheduler circuit 304. The second state 1000(2) is based on the instructions 312 in the instruction list 346 listed at the bottom of FIG. 10B being dispatched by the scheduler circuit 304. As shown in FIG. 10B, all the register dependency indicators 374(0)-374(5) for the instruction entries 372(1)-372(7) in the register dependency tracking circuit 352 are cleared by the scheduler circuit 304 to the no dependency state. However, the load dependency information 368 is still retained in the load dependency indicators 370(1)-370(7) for the load instruction entries L₀-L_{X} in the load dependency tracking circuit 366 in case the register dependency indicators 374(0)-374(5) for the instruction entries 372(1)-372(7) in the register dependency tracking circuit 352 need to be restored for replaying the load-dependent instructions 312D in the event of a cache miss during execution of the load instruction 312L. As will be discussed below, the load dependency tracking circuit 366 is configured to cause the shadow register dependency tracking circuit 356, shown in FIG. 3, to restore the dependency states in the register dependency indicators 374(0)-374(5) for the instruction entries 372(1)-372(7) in the register dependency tracking circuit 352 in response to the replay request 354 based on the load dependency indicators 370(1)-370(7) for the load instruction entries L₀-L_{X} in the load dependency tracking circuit 366.

FIG. 10C is a logical diagram illustrating an exemplary third state 1000(3) of the load dependency tracking circuit 366, the register dependency tracking circuit 352, and the instruction valid circuit 360 in the scheduler circuit 304. The third state 1000(3) is based on the load data for the load instruction 312L incurring a cache miss when being executed in the execution circuit 322. As shown in FIG. 10C, the scheduler circuit 304 uses the dependency information in load dependency indicators 370(1), 370(4) for the load instruction entries L₀-L_{X} in the load dependency tracking circuit 366 to cause the corresponding instruction valid entries 376(1), 376(4) to be changed from an invalid state (‘0’) to a valid state (‘1’), meaning that the corresponding load-dependent instructions 312D that are directly load-dependent on the load instruction 312L are to be replayed. In this example, the replay circuit 364 is configured to generate and broadcast a corresponding replay command 380(1), 380(4) based on the load dependency indicators 370(1), 370(4) that are set to the dependency state (‘1’) in the load dependency tracking circuit 366. This load dependency information 368 is known for the load instruction 312L, because as discussed above, the load dependency information 368 in the load dependency indicators 370(1)-370(7) for the load instruction entries L₀-L_{X} in the load dependency tracking circuit 366 after the load instruction 312L and its load-dependent instructions 312D are dispatched. In this example, replay commands 380(2), 380(5)-380(7) are generated by the load dependency tracking circuit 366, because registers R2 and R4-R7 are not source registers for the load-dependent instruction 312D that are directly dependent on the load instruction 312L. As discussed above, providing the load dependency tracking circuit 366 allows the register dependency information 353 in the register dependency tracking circuit 352 to be restored so that the load-dependent instructions 312D can be replayed, and without having to re-allocate and re-dispatch the load instruction 312L. The load instruction 312L can remain in the execution circuit 322 to be executed when its load data comes back from memory.

FIG. 10D is a logical diagram illustrating an exemplary fourth state 1000(4) of the load dependency tracking circuit 366, the register dependency tracking circuit 352 and the instruction valid circuit 360 in the scheduler circuit 304 that follows the third state 1000(3) in FIG. 10C. As shown in FIG. 10D, the instruction valid entries 376(1), 376(4) corresponding to the register dependency information 353 in the load dependency indicators 370(1), 370(4) for the load instruction entries L₀-L_{X} in the load dependency tracking circuit 366 are changed to the valid state (‘1’). The generation of the replay commands 380(1), 380(4) by the replay circuit 364 based on the load dependency tracking circuit 366 causes the shadow register dependency tracking circuit 356 to restore the shadow dependency states to the register dependency indicators 374(0), 374(4) for the instruction entries 372(1), 372(5) in the register dependency tracking circuit 352 since the next order of dependency for the load-dependent instructions 312D is for source registers R1 and R4.

FIG. 10E is a logical diagram illustrating an exemplary fifth state 1000(5) of the load dependency tracking circuit 366, the register dependency tracking circuit 352, and the instruction valid circuit 360 in the scheduler circuit 304 that follows the fourth state 1000(4) in FIG. 10D. As shown in FIG. 10E, the register dependency indicators 374(0), 374(4) for the instruction entries 372(1), 372(5) are restored. The instruction valid entries 376(1), 376(4) corresponding to the dependency information in load dependency indicators 370(1), 370(4) for the load instruction entries L₀-L_{X} in the load dependency tracking circuit 366 are in the valid state (‘1’). The scheduler circuit 304 uses the dependency information in load dependency indicators 370(1), 370(4) for the load instruction entries L₀-L_{X} in the load dependency tracking circuit 366 to cause the corresponding instruction valid entries 376(2), 376(5) to be changed from an invalid state (‘O’) to a valid state (‘1’), meaning that the corresponding load-dependent instructions 312D that are directly load-dependent on the load instruction 312L corresponding to destination registers R1 and R5 are to be replayed. In this regard, as shown in FIG. 10E, the register dependency tracking circuit 352 is configured to issue valid restores 1002(2), 1002(5) as a result of the register dependency indicators 374(0), 374(4) for the instruction entries 372(1), 372(5) being restored.

FIG. 10F is a logical diagram illustrating an exemplary sixth state 1000(6) of the load dependency tracking circuit 366, the register dependency tracking circuit 352, and the instruction valid circuit 360 in the scheduler circuit 304 that follows the fifth state 1000(5) in FIG. 10E. As shown in FIG. 10F, the instruction valid entries 376(1), 376(4) corresponding to the dependency information in load dependency indicators 370(1), 370(4) for the load instruction entries L₀-L_{X} in the load dependency tracking circuit 366 are changed to the valid state (‘1’). The restoring of the shadow dependency states to the register dependency indicators 374(0), 374(4) for the instruction entries 372(1), 372(5) in the register dependency tracking circuit 352 causes the shadow dependency states to the register dependency indicators 374(2), 374(5) for the instruction entries 372(6), 372(7) in the register dependency tracking circuit 352 to be restored for the next order of dependency for the load-dependent instructions 312D relating to source registers R6 and R7.

FIG. 10G is a logical diagram illustrating an exemplary seventh state 1000(7) of the load dependency tracking circuit 366, the register dependency tracking circuit 352, and the instruction valid circuit 360 in the scheduler circuit 304 that follows the sixth state 1000(6) in FIG. 10F. As shown in FIG. 10G, the register dependency indicators 374(2), 374(5) for the instruction entries 372(6), 372(7) in the register dependency tracking circuit 352 are restored for the next order of dependency for the load-dependent instructions 312D relating to source registers R6 and R7. The scheduler circuit 304 uses the dependency information in load dependency indicators 370(6), 370(7) for the load instruction entries L₀-L_{X} in the load dependency tracking circuit 366 to cause the corresponding instruction valid entries 376(6), 376(7) to be changed from an invalid state (‘0’) to a valid state (‘1’), meaning that the corresponding load-dependent instructions 312D that are directly load-dependent on the load instruction 312L corresponding to destination registers R6 and R7 are to be replayed.

FIG. 10H is a logical diagram illustrating an exemplary eighth state 1000(8) of the load dependency tracking circuit 366, the register dependency tracking circuit 352, and the instruction valid circuit 360 in the scheduler circuit 304 that follows the seventh state 1000(7) in FIG. 10G. As shown in FIG. 10H, the instruction valid entries 376(1), 376(2), 376(4)-376(7) corresponding to the dependency information in load dependency indicators 370(1)-370(2), 370(4)-370(7) for the load instruction entries L₀-L_{X} in the load dependency tracking circuit 366 remain in the valid state (‘1’). The register dependency indicators 374(1)-374(2), 374(4)-374(5) for the instruction entries 372(1)-372(2), 372(4)-372(7) in the register dependency tracking circuit 352 based on the load dependency indicators 370(1)-370(2), 370(4)-370(7) for the load instruction entries L₀-L_{X} in the load dependency tracking circuit 366 are restored from the shadow register dependency tracking circuit 356. The register dependency tracking circuit 352 is now configured such that the scheduler circuit 304 can replay the load-dependent instructions 312D to be re-dispatched in order of their original dependencies before the load-dependent instructions 312D and the load instruction 312L were dispatched. In this example, note that the register dependency indicators 374(0) for register R0 for the instruction entries 372(1)-372(7) is now ‘0’ in FIG. 10H, meaning no dependency exists, because the load instruction 312L does not have to be re-dispatched to be executed in response to load cache miss. As discussed above, the load instruction 312L is executed in the execution circuit 322 (FIG. 3) and only its load-dependent instructions 312D need to be re-dispatched. Thus, the register dependency indicator 374(0) for register R0 for the instruction entries 372(1)-372(7) does not have to be restored for a replay operation.

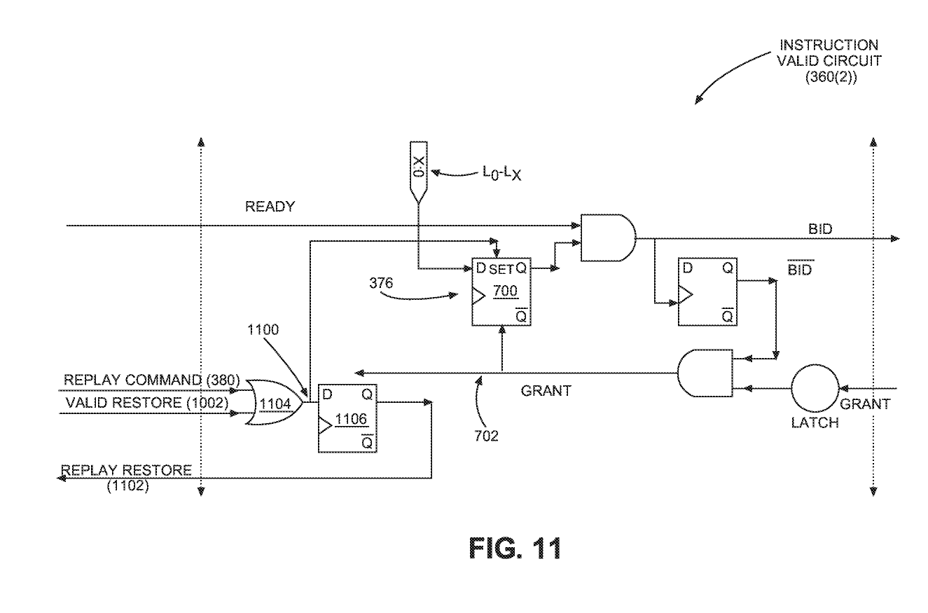

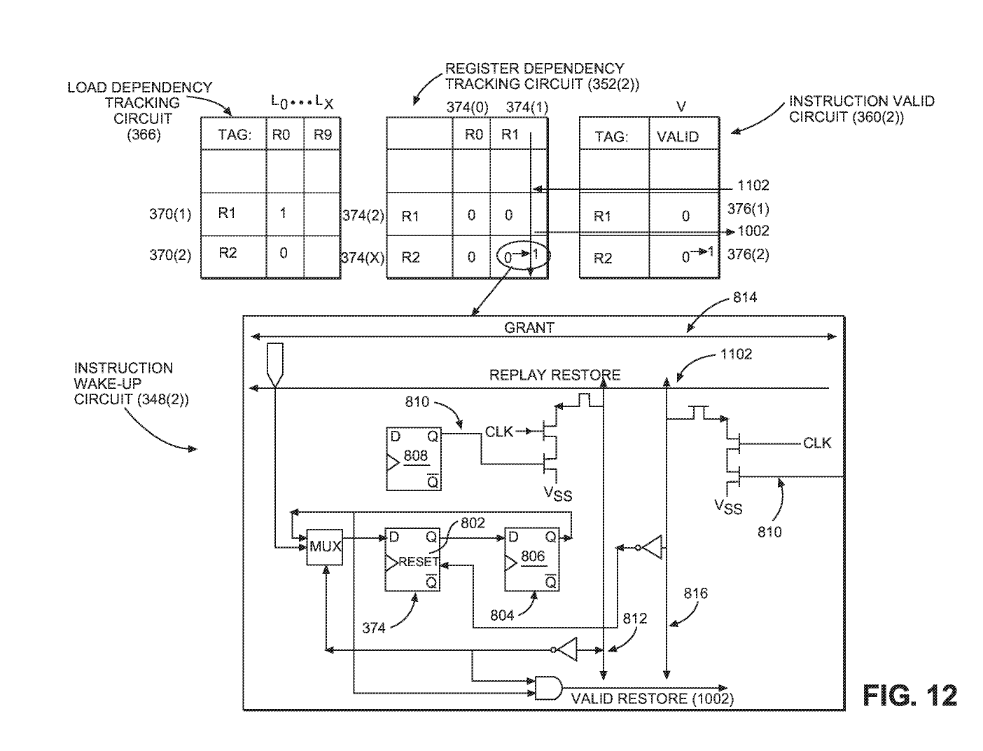

FIG. 11 is a schematic diagram of an exemplary instruction valid circuit 360(2) that can be provided for each instruction valid entry 376(1)-376(X) in the scheduler circuit 304 in FIG. 3 for storing and restoring a corresponding instruction valid entry 376 associated with load-dependent instructions 312D to be replayed, in response to the replay circuit 364(1) in FIG. 6 issuing the replay command 380 for a replay operation. The instruction valid circuit 360(2) in FIG. 11 is similar to the instruction valid circuit 360(1) in FIG. 7 that has been previously described, with common components shown with comment element numbers between FIGS. 7 and 11. However, as shown in FIG. 11, the instruction valid circuit 360(2) is configured to set the storage circuit 700 based on an output signal 1100 generated by an OR-based gate 1104 from the replay command 380 and a valid restore 1002. The instruction valid circuit 360(2) is also configured to generate a replay restore 1102 in response to the replay command 380 or the valid restore 1002 being active. In this manner, the instruction valid entries 376 can be set based on the replay command 380 being issued by the replay circuit 364 in response to the direct load-dependent instructions 312D being replayed. The instruction valid entries 376 can also be set based on the valid restore 1002 issued by the instruction wake-up circuit 348(2) (discussed in FIG. 12 below) in response for direct load-dependent instructions 312D to be replayed, as shown by example in FIG. 10E above. This allows for the instruction valid entries 376(1)-376(X) in the instruction valid circuit 360(2) to be updated in sequence based on the order of dependencies in the load-dependent instructions 312D.

FIG. 12 is a schematic diagram of an exemplary register dependency indicator 374 for a register dependency tracking circuit 352(2) that can be included in the scheduler circuit 304 in FIG. 3. The instruction valid circuit 360(2) in FIG. 11 is similar to the instruction valid circuit 360(1) in FIG. 7 that has been previously described, with common components shown with comment element numbers between FIGS. 7 and 12. However, as shown in FIG. 12, the instruction wake-up circuit 348(2) is configured to issue the valid restore 1002 in response to restoring the register dependency indicators 374(0)-374(X) for the instruction entries 372(1)-372(Y) in the register dependency tracking circuit 352 and the replay restore 1102 issued by the instruction valid circuit 360(2) in FIG. 11 indicating that the instruction valid entry 376 corresponding to the register dependency indicator 374 is set. In this manner, the storing of the register dependency indicators 374(0)-374(X) causes the instruction valid circuit 360(2) in FIG. 11 to restore the instruction valid entries 376(1)-376(X) for the next dependency order of load-dependent instructions 312D to be replayed. The valid restore 1002 is issued as a result of the replay command 380 being unasserted and the storage circuit 806 for the shadow register dependency indicator 804 restoring the register dependency stored therein in the register dependency indicator 374.

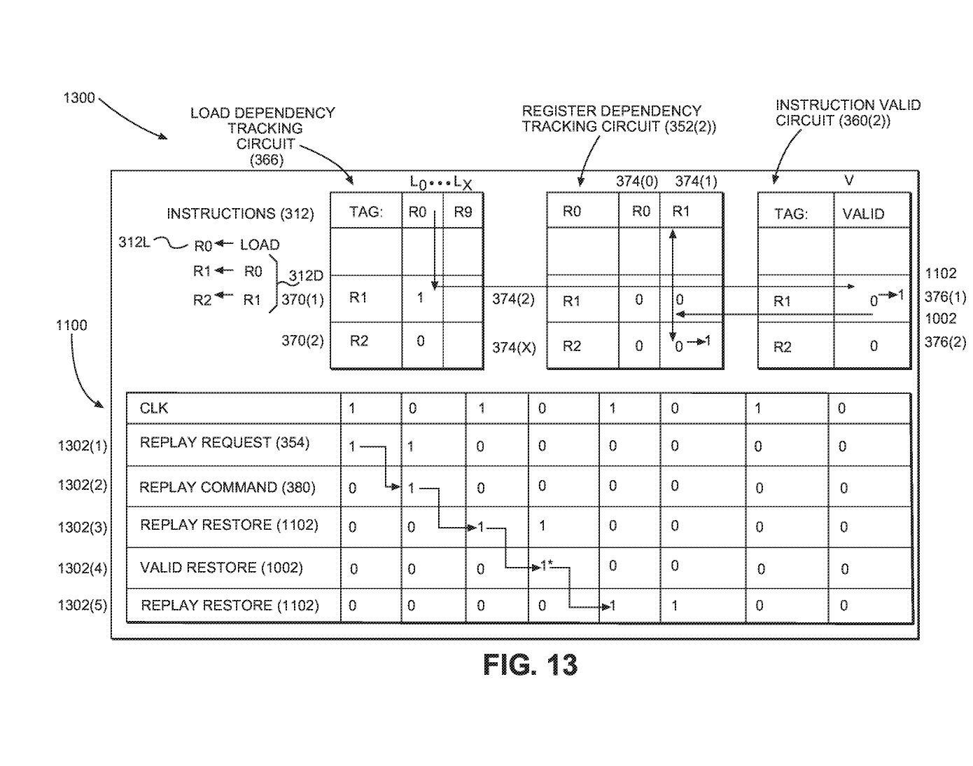

To summarize FIGS. 10A-12, FIG. 13 is a timing diagram 1300 illustrating an exemplary time sequence 1302(1)-1302(5) of signals generated in the replay circuit 364(1) in FIG. 6, the instruction valid circuit 360(2) in FIG. 11, and the instruction wake-up circuit 348(2) in FIG. 12, in response to a clock signal CLK. The generation of signals in the time sequence 1302(1)-1302(5) sequences the restoration of register dependencies in the register dependency tracking circuit 352 in response to a replay request 354 in response to a cache miss for a load instruction 312L, for replaying the dispatch of load-dependent instructions 312D for a replay operation. As shown in FIG. 13, in response to a replay request 354 in time sequence 1302(1), a replay command 380 is generated by the replay circuit 364(1) in FIG. 6 in time sequence 1302(2) based on the register dependency indicated in the relay request 354 for the dependent load instruction 312 that incurred a load cache miss. In response, the replay command 380 is received by the instruction valid circuit 360(2) in FIG. 11 and an instruction valid entry 376 corresponding to a next order register dependency is updated in the instruction valid circuit 360(2). In response to updating of the instruction valid entry 376, a corresponding replay restore 1102 is issued by the instruction valid circuit 360(2) in FIG. 11 in time sequence 1302(3). This causes the shadow register dependency information 804 in the shadow register dependency tracking circuit 356 in the instruction valid circuit 360(2) in FIG. 12 to restore the valid restore 1002 in the register dependency tracking circuit 352(2) for the next order register dependency so that the corresponding load-dependent instruction 312D will be re-dispatched. In response, if there are next order dependencies that need to be restored in the register dependency tracking circuit 352(2), the instruction wake-up circuit 348(2) issues the valid restore 1002 in time sequence 1302(4). In response, a corresponding replay restore 1102 is issued by the instruction wake-up circuit 348(2) in FIG. 12 in time sequence 1302(5) for next order dependencies. Time sequences 1302(4) and 1302(5) repeat in a time-sequential fashion until all the register dependencies are restored in the registered dependency tracking circuit 352(2).

A processor-based system that includes a processor that includes a scheduler circuit configured to speculatively dispatch for execution, load-dependent instructions dependent on a dispatched load instruction, and replay such load-dependent instructions in a replay operation based on restored register dependencies for the load-dependent instructions, in response to a cache miss for the producing load instruction, can be provided in circuits and means described above or in other means in addition to those described above. For example, a scheduler circuit can be provided that includes a means for updating register dependency information in a plurality of instruction entries, each instruction entry among the plurality of instruction entries corresponding to register dependency information of a dependent instruction to be dispatched. Non-limiting examples of this are shown in the non-limiting examples in FIGS. 3, 7, and 12. The scheduler circuit can also include a means for updating shadow register dependency information in a plurality of shadow instruction entries, each shadow instruction entry among the plurality of shadow instruction entries corresponding to the register dependency information in an instruction entry for the dependent instruction to be dispatched. Non-limiting examples of this are shown in the non-limiting examples in FIGS. 3, 7, and 12. The scheduler circuit can also include a means for issuing a replay command for register load dependencies indicated in a plurality of load instruction entries, in response to a received replay request for a register corresponding to a dispatched load instruction. Non-limiting examples of this are shown in the non-limiting examples in FIGS. 3 and 6. The scheduler circuit can also include a means for restoring the shadow register dependency information from the plurality of shadow instruction entries in response to the means for issuing the replay command for each register load dependency, into the register dependency information in the plurality of instruction entries corresponding to the means for updating the shadow register dependency information for each register load dependency. Non-limiting examples of this are in FIGS. 3, 7, and 12.

A processor-based system that includes a processor that includes one or more processor cores that each can be an OoP that include a scheduler circuit configured to speculatively dispatch for execution, load-dependent instructions dependent on a dispatched load instruction, and replay such load-dependent instructions in a replay operation based on restored register dependencies for the load-dependent instructions, in response to a cache miss for the producing load instruction, including but not limited to the scheduler circuit 304 in FIGS. 3, 7-9, 11, and 12, as a non-limiting examples, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

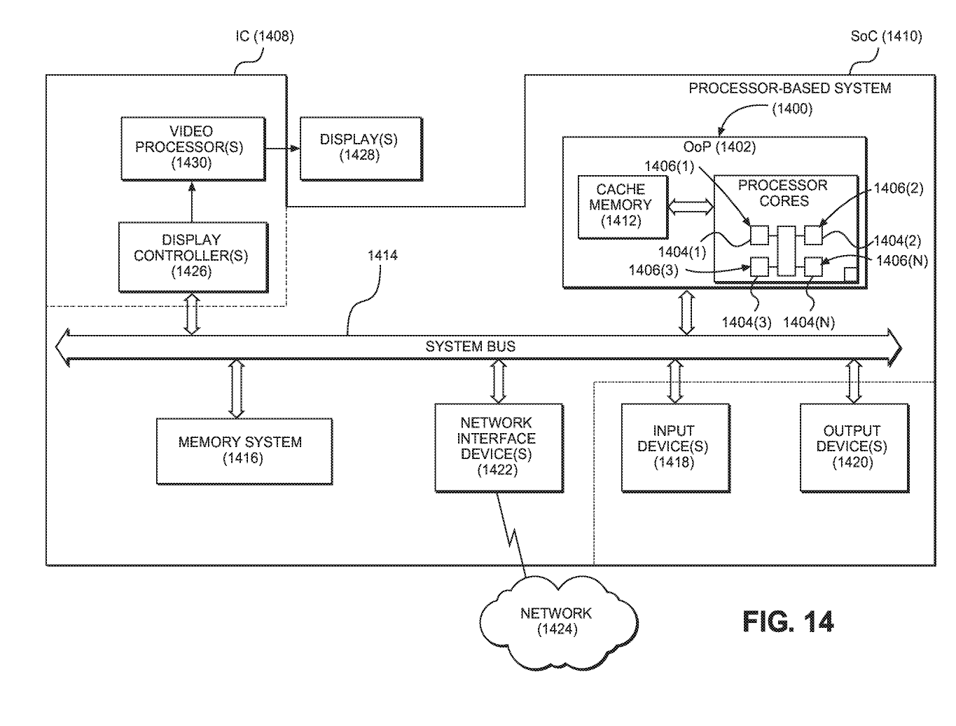

FIG. 14 illustrates an example of a processor-based system 1400 that includes an OoP 1402, such as the OoP 302 in FIG. 3 as a non-limiting example, and includes one or more processor cores 1404(1)-1404(N) that each include a scheduler circuit 1406(1)-1406(N) configured to speculatively dispatch for execution, load-dependent instructions dependent on a dispatched load instruction, and replay such load-dependent instructions in a replay operation based on restored register dependencies for the load-dependent instructions, in response to a cache miss for the producing load instruction. The processor cores 1404(1)-1404(N) may each have a private cache memory used to store data, including load data for executing load instructions.

In this example, the processor-based system 1400 is provided in an IC 1408. The IC 1408 may be included in or provided as a SoC 1410 as an example. The OoP 1402 may have a cache memory 1412 shared between the processor cores 1404(1)-1404(N) for rapid access to temporarily stored data. The OoP 1402 is coupled to a system bus 1414 and can intercouple master and slave devices included in the processor-based system 1400. As is well known, the OoP 1402 communicates with these other devices by exchanging address, control, and data information over the system bus 1414. Although not illustrated in FIG. 14, multiple system buses 1414 could be provided, wherein each system bus 1414 constitutes a different fabric. For example, the OoP 1402 can communicate bus transaction requests to a memory system 1416 as an example of a slave device.

Other master and slave devices can be connected to the system bus 1414. As illustrated in FIG. 14, these devices can include the memory system 1416 and one or more input devices 1418. The input device(s) 1418 can include any type of input device, including but not limited to input keys, switches, voice processors, etc. The input device(s) 1418 may be included in the IC 1408 or external to the IC 1408, or a combination of both. Other devices that can be connected to the system bus 1414 can also include one or more output devices 1420, and one or more network interface devices 1422. The output device(s) 1420 can include any type of output device, including but not limited to audio, video, other visual indicators, etc. The output device(s) 1420 may be included in the IC 1408 or external to the IC 1408, or a combination of both. The network interface device(s) 1422 can be any devices configured to allow exchange of data to and from a network 1424. The network 1424 can be any type of network, including but not limited to a wired or wireless network, a private or public network, a local area network (LAN), a wireless local area network (WLAN), a wide area network (WAN), a BLUETOOTH™ network, and the Internet. The network interface device(s) 1422 can be configured to support any type of communications protocol desired.

Other devices that can be connected to the system bus 1414 can also include one or more display controllers 1426 as examples. The OoP 1402 may be configured to access the display controller(s) 1426 over the system bus 1414 to control information sent to one or more displays 1428. The display controller(s) 1426 can send information to the display(s) 1428 to be displayed via one or more video processors 1430, which process the information to be displayed into a format suitable for the display(s) 1428. The display controller(s) 1426 and/or the video processor(s) 1430 may be included in the IC 1408 or external to the IC 1408, or a combination of both.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A scheduler circuit for dispatching instructions in an instruction pipeline in an out-of-order processor (OoP), configured to:
update register dependency information in a plurality of instruction entries in a register dependency tracking circuit, each instruction entry among the plurality of instruction entries corresponding to register dependency information of a dependent instruction to be dispatched; and
update shadow register dependency information in a plurality of shadow instruction entries in a shadow register dependency tracking circuit, each shadow instruction entry among the plurality of shadow instruction entries corresponding to the register dependency information in an instruction entry in the register dependency tracking circuit for the dependent instruction to be dispatched; and
further comprising a replay circuit configured to issue a replay command for register load dependencies indicated in a plurality of load instruction entries in a load dependency tracking circuit, in response to a received replay request for a register corresponding to a dispatched load instruction; and
the scheduler circuit further configured to:
restore the shadow register dependency information from the plurality of shadow instruction entries in the shadow register dependency tracking circuit in response to the replay command issued by the replay circuit for each register load dependency, into the register dependency information in the plurality of instruction entries in the register dependency tracking circuit corresponding to the shadow register dependency information for each register load dependency from the replay circuit.

2. The scheduler circuit of claim 1, wherein:
each instruction entry among the plurality of instruction entries in the register dependency tracking circuit comprises a plurality of register dependency indicators each indicating a dependency state to a unique register among a plurality of registers for the corresponding instruction entry;
each shadow instruction entry among the plurality of shadow instruction entries in the shadow register dependency tracking circuit comprises a plurality of shadow register dependency indicators each indicating the dependency state to a unique register among the plurality of registers for the corresponding shadow instruction entry; and
each load instruction entry among the plurality of load instruction entries in the load dependency tracking circuit comprises a plurality of register load dependency indicators each indicating a register load dependency state to a unique register among the plurality of registers for the corresponding load instruction entry;
the replay circuit configured to issue the replay command for each register load dependency indicator in the plurality of load instruction entries indicating a load dependency in the load dependency tracking circuit, in response to the received replay request for the register corresponding to the dispatched load instruction; and
the scheduler circuit configured to:
update the dependency state of the plurality of register dependency indicators in the plurality of instruction entries in the register dependency tracking circuit, corresponding to register dependency information of the dependent instruction to be dispatched;
update the shadow dependency state of the plurality of shadow register dependency indicators in the plurality of shadow instruction entries in the shadow register dependency tracking circuit, corresponding to the dependent instruction to be dispatched, in response to updating the register dependency state of the plurality of register dependency indicators in the register dependency tracking circuit; and
restore the shadow dependency state in the plurality of shadow register dependency indicators in plurality of shadow instruction entries in the shadow register dependency tracking circuit, corresponding to the issued replay command for each register load dependency from the replay circuit, as the dependency state in each corresponding register dependency indicator for each instruction entry in the register dependency tracking circuit.

3. The scheduler circuit of claim 1, wherein the replay circuit is further configured to, for the dispatched load instruction:
assign a load instruction entry in the load dependency tracking circuit to the dispatched load instruction; and
update register load dependency information in the load instruction entry in the load dependency tracking circuit based on load dependency registers in load-dependent instructions to the dispatched load instruction.

4. The scheduler circuit of claim 1, further configured to speculatively dispatch a load-dependent instruction in response to the register dependency information in an instruction entry in the register dependency tracking circuit corresponding to the load-dependent instruction indicating no register dependency.

5. The scheduler circuit of claim 4, further configured to re-dispatch the load-dependent instruction in response to the register dependency information in the instruction entry in the register dependency tracking circuit corresponding to the load-dependent instruction indicating no register dependency, after the scheduler circuit restores the shadow register dependency information for the plurality of shadow instruction entries in the shadow register dependency tracking circuit corresponding to the load-dependent instruction.

6. The scheduler circuit of claim 3, wherein the replay circuit is further configured to, for the dispatched load instruction:
assign a load instruction entry in the load dependency tracking circuit to the dispatched load instruction; and
update the register load dependency information in the load instruction entry in the load dependency tracking circuit based on the load dependency registers in direct and indirect load-dependent instructions to the dispatched load instruction.

7. The scheduler circuit of claim 6, wherein the replay circuit is configured to issue the replay command for each direct and indirect register dependency indicated in the register load dependency information corresponding to the load instruction entry in the load dependency tracking circuit, in response to the received replay request for the register corresponding to the dispatched load instruction.

8. The scheduler circuit of claim 3, wherein the replay circuit is further configured to, for the dispatched load instruction:
assign a load instruction entry in the load dependency tracking circuit to the dispatched load instruction; and
update the register load dependency information in the load instruction entry in the load dependency tracking circuit based on the load dependency registers in only direct load-dependent instructions to the dispatched load instruction.

9. The scheduler circuit of claim 8, wherein the replay circuit is configured to issue the replay command for only each direct register dependency indicated in the register load dependency information corresponding to the load instruction entry in the load dependency tracking circuit, in response to the received replay request for the register corresponding to the dispatched load instruction.

10. The scheduler circuit of claim 9, further configured to update the register load dependency information in the load instruction entry in the load dependency tracking circuit based on the load dependency registers in indirect load-dependent instructions dependent on the direct load-dependent instructions, in response to the replay circuit issuing the replay command for register load dependencies indicated in the plurality of load instruction entries in the load dependency tracking circuit.

11. The scheduler circuit of claim 8, further configured to re-dispatch a load-dependent instruction directly dependent on the dispatched load instruction, in response to the register dependency information in the instruction entry in the register dependency tracking circuit corresponding to the load-dependent instruction indicating no register dependency, after the scheduler circuit restores the shadow register dependency information in the shadow register dependency tracking circuit corresponding to the direct load-dependent instruction.

12. The scheduler circuit of claim 1, further comprising an instruction valid circuit comprising a plurality of instruction valid entries each configured to store instruction valid information corresponding to an instruction entry in the register dependency tracking circuit;
the scheduler circuit configured to update instruction valid information in an instruction valid entry corresponding to the instruction entry corresponding to a dependent instruction to be dispatched having a register dependency.

13. The scheduler circuit of claim 12, configured to update the register dependency information in the plurality of instruction entries in the register dependency tracking circuit corresponding to register dependencies of the dependent instruction to be dispatched, in response to:
updating the instruction valid information in the instruction valid entry corresponding to the instruction entry corresponding to the dependent instruction to be dispatched having the register dependency.

14. The scheduler circuit of claim 1 integrated into an integrated circuit (IC).

15. The scheduler circuit of claim 1 integrated into a system-on-a-chip (SoC).

16. The scheduler circuit of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device (e.g., a smart watch, a health or fitness tracker, eyewear, etc.); a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

17. A scheduler circuit for dispatching instructions in an instruction pipeline in an out-of-order processor (OoP), comprising:
a means for updating register dependency information in a plurality of instruction entries, each instruction entry among the plurality of instruction entries corresponding to register dependency information of a dependent instruction to be dispatched;
a means for updating shadow register dependency information in a plurality of shadow instruction entries, each shadow instruction entry among the plurality of shadow instruction entries corresponding to the register dependency information in an instruction entry for the dependent instruction to be dispatched;
a means for issuing a replay command for register load dependencies indicated in a plurality of load instruction entries, in response to a received replay request for a register corresponding to a dispatched load instruction; and
a means for restoring the shadow register dependency information from the plurality of shadow instruction entries in response to the means for issuing the replay command for each register load dependency, into the register dependency information in the plurality of instruction entries corresponding to the means for updating the shadow register dependency information for each register load dependency.

18. A method of scheduling instructions for dispatch to an execution unit in an instruction pipeline of an out-of-order processor (OoP), comprising:
updating register dependency information in a plurality of instruction entries in a register dependency tracking circuit, each instruction entry among the plurality of instruction entries corresponding to register dependency information of a dependent instruction to be dispatched;
updating shadow register dependency information in a plurality of shadow instruction entries in a shadow register dependency tracking circuit, each shadow instruction entry among the plurality of shadow instruction entries corresponding to the register dependency information in an instruction entry in the register dependency tracking circuit for the dependent instruction to be dispatched;
issuing a replay command for register load dependencies indicated in a plurality of load instruction entries in a load dependency tracking circuit, in response to a received replay request for a register corresponding to a dispatched load instruction; and
restoring the shadow register dependency information from the plurality of shadow instruction entries in the shadow register dependency tracking circuit in response to issuing the replay command for each register load dependency, into the register dependency information in the plurality of instruction entries in the register dependency tracking circuit corresponding to the shadow register dependency information for each register load dependency.

19. The method of claim 18, further comprising, for the dispatched load instruction:
assigning a load instruction entry in the load dependency tracking circuit to the dispatched load instruction; and
updating register load dependency information in the load instruction entry in the load dependency tracking circuit based on load dependency registers in load-dependent instructions to the dispatched load instruction.

20. The method of claim 18, further comprising speculatively dispatching a load-dependent instruction in response to the register dependency information in an instruction entry in the register dependency tracking circuit corresponding to the load-dependent instruction indicating no register dependency.

21. The method of claim 20, further comprising re-dispatching the load-dependent instruction in response to the register dependency information in the instruction entry in the register dependency tracking circuit corresponding to the load-dependent instruction indicating no register dependency, after restoring the shadow register dependency information for the plurality of shadow instruction entries in the shadow register dependency tracking circuit corresponding to the load-dependent instruction.

22. The method of claim 19, further comprising, for the dispatched load instruction:
assigning a load instruction entry in the load dependency tracking circuit to the dispatched load instruction; and
updating the register load dependency information in the load instruction entry in the load dependency tracking circuit based on the load dependency registers in direct and indirect load-dependent instructions to the dispatched load instruction.

23. The method of claim 22, comprising issuing the replay command for each direct and indirect register dependency indicated in the register load dependency information corresponding to the load instruction entry in the load dependency tracking circuit, in response to the received replay request for the register corresponding to the dispatched load instruction.

24. The method of claim 19, further comprising, for the dispatched load instruction:
assigning a load instruction entry in the load dependency tracking circuit to the dispatched load instruction; and
updating the register load dependency information in the load instruction entry in the load dependency tracking circuit based on the load dependency registers in only direct load-dependent instructions to the dispatched load instruction.

25. The method of claim 24, comprising issuing the replay command for only each direct register dependency indicated in the register load dependency information corresponding to the load instruction entry in the load dependency tracking circuit, in response to the received replay request for the register corresponding to the dispatched load instruction.

26. The method of claim 25, further comprising updating the register load dependency information in the load instruction entry in the load dependency tracking circuit based on the load dependency registers in indirect load-dependent instructions dependent on the direct load-dependent instructions, in response to the replay circuit issuing the replay command for register load dependencies indicated in the plurality of load instruction entries in the load dependency tracking circuit.

27. The method of claim 24, further comprising re-dispatching a load-dependent instruction directly dependent on the dispatched load instruction, in response to the register dependency information in the instruction entry in the register dependency tracking circuit corresponding to the load-dependent instruction indicating no register dependency, after a scheduler circuit restores the shadow register dependency information in the shadow register dependency tracking circuit corresponding to the direct load-dependent instruction.

28. The method of claim 19, further comprising updating instruction valid information in an instruction valid entry corresponding to the instruction entry corresponding to a dependent instruction to be dispatched having a register dependency.

29. A processor-based system, comprising:
a cache memory configured to cache load data from a system memory; and
an out-of-order processor (OoP), comprising:
an execution circuit configured to execute dispatched instructions; and
a dispatch circuit configured to dispatch instructions to the execution circuit;
the dispatch circuit configured to:
update register dependency information in a plurality of instruction entries in a register dependency tracking circuit, each instruction entry among the plurality of instruction entries corresponding to register dependency information of a dependent instruction to be dispatched;
update shadow register dependency information in a plurality of shadow instruction entries in a shadow register dependency tracking circuit, each shadow instruction entry among the plurality of shadow instruction entries corresponding to the register dependency information in an instruction entry in the register dependency tracking circuit for the dependent instruction to be dispatched; and
restore the shadow register dependency information from the plurality of shadow instruction entries in the shadow register dependency tracking circuit in response to a replay command issued by a replay circuit for each register load dependency, into the register dependency information in the plurality of instruction entries in the register dependency tracking circuit corresponding to the shadow register dependency information for each register load dependency from the replay circuit;
the execution circuit configured to issue a replay request in response to a cache miss to the cache memory in response to execution of a load instruction dispatched from the dispatch circuit; and
the dispatch circuit further configured to issue the replay command for the register load dependencies indicated in a plurality of load instruction entries in a load dependency tracking circuit, in response to the received replay request for a register corresponding to a dispatched load instruction.

30. The processor-based system of claim 29, wherein the dispatch circuit is further configured to speculatively dispatch a load-dependent instruction in response to register dependency information in an instruction entry in the register dependency tracking circuit corresponding to the load-dependent instruction indicating no register dependency.
